(19) United States
(12) Patent Application Publication
(10) Pub. No.: US 2021/0104744 A1
(43) Pub. Date: Apr. 8, 2021

(54) SECONDARY BATTERY AND MANUFACTURING METHOD THEREOF

(71) Applicant: SEMICONDUCTOR ENERGY LABORATORY CO., LTD., Atsugi-shi, Kanagawa-ken (JP)

(72) Inventors: Teppei OGUNI, Atsugi, Kanagawa (JP); Aya UCHIDA, Oyama-shi, Tochigi-ken (JP); Hiroshi KADOMA, Sagamihara, Kanagawa (JP)

(21) Appl. No.: 16/464,566

(22) PCT Filed: Dec. 4, 2017
(86) PCT No.: PCT/IB2017/057598

§ 371 Date: May 28, 2019

(30) Foreign Application Priority Data
Dec. 9, 2016 (JP) 2016-239821

(51) Int. Cl. H01M 4/583; H01M 10/0562; H01M 4/133

(52) U.S. Cl. CPC H01M 4/583; H01M 2004/027; H01M 4/133; H01M 10/0562

(57) ABSTRACT

Provided is a layer for preventing a short circuit between a positive electrode and a negative electrode in a solid battery using a layer containing a solid electrolyte. As the solid electrolyte between the positive electrode and the negative electrode, a layer containing a graphene compound is used. Lithium ions can pass through the layer containing the graphene compound. Lithium ions are added in advance in the layer containing the graphene compound. Specifically, a modifier is used, and a graphene compound chemically modified with a functional group such as ether and ester with an increased interlayer distance is used.

### TECHNICAL FIELD

One embodiment of the present invention relates to an object, a method, or a manufacturing method. The present invention relates to a process, a machine, manufacture, or a composition of matter. One embodiment of the present invention relates to a method for manufacturing a semiconductor device, a display device, a light-emitting device, a power storage device, a lighting device, or an electronic device. In particular, one embodiment of the present invention relates to an electronic device and its operating system.

Note that electronic devices in this specification generally mean devices including power storage devices, and electro-optical devices including power storage devices, information terminal devices including power storage devices, and the like are all electronic devices.

### BACKGROUND ART

Electronic devices carried around by the users and electronic devices worn by the users have been actively developed.

Portable electronic devices and wearable electronic devices operate using primary batteries or secondary batteries, which are examples of a power storage device, as power sources. It is desired that a portable electronic device can withstand long time use; thus, a high-capacity secondary battery can be used. However, a high-capacity secondary battery is large in size; thus, the weight of an electronic device including the high-capacity secondary battery is increased. In view of the problem, small or thin high-capacity secondary batteries that can be incorporated in portable electronic devices are under development.

A lithium ion secondary battery using liquid such as an organic solvent as a transmission medium of lithium ions is widely used. However, a secondary battery using liquid has problems in the operable temperature range or liquid leakage to the outside of the secondary battery. In addition, it is difficult to reduce the thickness of a secondary battery using liquid as an electrolyte because the liquid leakage needs to be avoided.

A fuel battery is a secondary battery using no liquid. However, noble metals are used for the electrodes, and a material of a solid electrolyte is also expensive.

In addition, as a secondary battery using no liquid, a power storage device using a solid electrolyte, which is called a solid battery, is known and disclosed in Patent Documents 1 and 2, for example. Patent Document 3 discloses an example of using any one of a solvent, gel, and a solid electrolyte as an electrolyte of a lithium ion secondary battery.

Patent Document 4 discloses an example of using a graphene oxide for a positive electrode active material layer of a solid battery.

### REFERENCE

[Patent Document I] Japanese Published Patent Application No. 2012-230889
[Patent Document 2] Japanese Published Patent Application No. 2012-023032
[Patent Document 3] Japanese Published Patent Application No. 2013-229308
[Patent Document 4] Japanese Published Patent Application No. 2013-229315

### DISCLOSURE OF INVENTION

A power storage device includes a member called a separator (or a short circuit prevention film) for isolating a positive electrode from a negative electrode for preventing a short circuit between the electrodes. Repeated charging causes lithium deposition on the negative electrode, which becomes a cause of the short circuit. The separator is said to have a function of preventing a short circuit between the positive electrode and the negative electrode.

In order to achieve the downsizing and high output of a power storage device, a layer containing a solid electrolyte is used instead of an organic electrolyte solution to abricate a solid battery. As compared to a secondary battery using an organic electrolyte solution, a solid battery is less likely to ignite and thus is safer. The separator is not used in the solid battery in some cases because the layer containing a solid electrolyte provided between the positive electrode and the negative electrode prevents the short circuit between them and serves as a separator.

A solid electrolyte should have basic properties of high conductivity of ions that transfer electric charges and low conductivity of electrons in order to prevent a short circuit between a positive electrode and a negative electrode. An object of one embodiment of the present invention is to provide a layer for preventing a short circuit between a positive electrode and a negative electrode in a solid battery including a layer containing a solid electrolyte.

Another object of one embodiment of the present invention is to provide a highly reliable power storage device. Another object of one embodiment of the present invention is to provide a long-life power storage device.

Another object of one embodiment of the present invention is to provide a power storage device with a high degree of safety. Another object of one embodiment of the present invention is to provide a novel power storage device, a novel electrode, or the like.

One embodiment of the present invention provides a power storage device which achieves at least one of the above objects. Note that the descriptions of these objects do not disturb the existence of other objects. In one embodiment of the present invention, there is no need to achieve all the objects, Other objects will be apparent from and can be derived from the description of the specification, the drawings, the claims, and the like.

A layer containing a graphene compound is used as a layer for preventing a short circuit between a positive electrode and a negative electrode in a solid battery. When the layer containing a graphene compound is used as a new material of a solid battery, the range of choices for materials of a solid battery can be widened. Moreover, the combination of materials can be increased, and a novel solid battery can be provided.

A secondary battery disclosed in this specification is characterized by including a first electrode containing a positive electrode active material, a second electrode containing a negative electrode active material, and a layer containing a graphene compound. The layer containing a graphene compound has ion conductivity and a function of preventing a short circuit between the first electrode and the second electrode.

Since the layer for preventing a short circuit between the positive electrode and the negative electrode is formed, an appropriate molecule is bonded or adsorbed to a graphene compound, so that at least part of the surface of the graphene compound can be chemically modified. A compound obtained by chemically modifying at least part of the surface of the graphene compound may be referred to as surface-modified graphene.

In this specification, modifying may refer to chemically changing a graphene compound to change the function or property. Moreover, modifying may refer to adding a functional group having a certain function or property.

Lithium ions can pass through the layer containing a graphene compound. In addition, lithium ions are added in advance to the layer containing a graphene compound.

A solid electrolyte is a layer with a property of transmitting ions such as lithium ions and an insulating property in the state where voltage is applied between a positive electrode and a negative electrode. In order to improve the output characteristics of a battery, the distance of movement of ions is preferably reduced. When the thickness of the layer containing a graphene compound is reduced, the internal resistance is reduced, so that the output characteristics of a battery are improved. Note that it is preferable to ensure the minimum thickness of the layer containing a graphene compound for preventing a short circuit between a positive electrode and a negative electrode.

Specifically, a modifier is used, and a graphene compound chemically modified with a functional group such as ether and ester with an increased interlayer distance is used.

A power storage device needs to have both high energy density and high output density. Thus, an excellent battery needs to have not only high efficiency but also low internal resistance. For improving energy density of a battery, a large amount of lithium is included in a certain size. For improving power output density, the distance between electrodes is reduced.

To increase the capacity, a plurality of units each sandwiched between a positive electrode and a negative electrode may be used. For example, the positive electrode, a first solid electrolyte, a chemically modified graphene compound, a second solid electrolyte, and the negative electrode are stacked repeatedly in this order. A cell with such a structure is referred to as a bipolar cell.

When an external pressure is applied to a power storage device for some reasons, deformation might be caused in a solid electrolyte included in a secondary battery, specifically, the solid electrolyte might be crushed partly, leading to a short circuit between a positive electrode and a negative electrode with a decreased distance. Since a graphene compound is resistant to deformation, a solid electrolyte using the graphene compound can be prevented from being deformed by an external pressure.

Polyethylene oxide (PEO) is known as a polymer which can be used for a lithium-ion secondary battery. The melting point of PEO is around 60° C., and the temperature range is narrow because there is a danger of a short circuit between electrodes by the melting. A solid electrolyte using a layer containing a graphene compound can be more resistant at high temperatures than a polymer-based solid electrolyte like PEO, and a power storage device including the solid electrolyte can be used in a wide temperature range. Moreover, when the layer containing a graphene compound has higher allowable temperature limit to be incombustible, high reliability and resistance to breakdown and ignition can be expected.

In contrast, a conventional separator using an electrolyte solution made of a polyolefin-based material in a power storage device has a small hole. When the temperature reaches or exceeds a predetermined temperature due to a battery abnormality, the separator becomes softened and a partially melted state. The small hole, which serves as a path of a lithium ion, is closed in the melted state, and movement of a lithium ion is stopped, so that a current flow between the inside and outside of the battery is stopped.

A separator in a power storage device using an electrolyte solution and a separator in a power storage device using a solid electrolyte have the same name but differ in required performance. Since the electrolyte solution is used as the separator in the power storage device using an electrolyte solution, a material which is permeable to the electrolyte solution, such as woven fabric or nonwoven fabric of polyethylene or polypropylene having a small hole where the electrolyte solution passes and a glass fiber, is used. In this specification, the separator in a power storage device using a solid electrolyte means a solid electrolyte layer or a layer containing a graphene oxide. In this specification, another separator is unnecessary, and the solid electrolyte layer or the layer containing a graphene oxide serves as a separator.

Any electrolyte having lithium-ion conductivity and containing a solid component can be used as the solid electrolyte without particular limitation. For example, ceramic, high molecular electrolytes, and the like can be given. High molecular electrolytes can be classified largely into a high molecular gel electrolyte containing an electrolyte solution and a high molecular electrolyte not containing an electrolyte solution.

One embodiment of the present invention can provide a solid electrolyte which is formed using a novel graphene compound and can withstand deformation. One embodiment of the present invention can provide a power storage device that can be changed in shape, i.e., a flexible power storage device.

In this specification, flexibility refers to a property of an object being flexible and bendable. In other words, it is a property of an object that can be changed in form in response to an external force applied to the object, and elasticity or restorability to the former shape is not taken into consideration. A flexible object can be deformed in response to an external force. A flexible object can be used with its shape fixed in a state of being deformed, can be used while repeatedly deformed, and can be used in a state of not deformed.

The solid electrolyte layer may have a two-layered structure. Another embodiment of the present invention is a secondary battery comprising a first electrode containing a positive electrode active material, a solid electrolyte layer, a layer containing a graphene compound, and a second electrode containing a negative electrode active material. The layer containing a graphene compound is between the solid electrolyte layer and the second electrode. The layer containing a graphene compound has an ion conductivity and is configured to prevent a short circuit between the first electrode and the second electrode.

The solid electrolyte layer may have a three-layered structure. Another embodiment of the present invention is a secondary battery comprising a first electrode containing a positive electrode active material, a first solid electrolyte layer, a second electrode containing a negative electrode active material, a second solid electrolyte layer, and a layer containing a graphene compound. The layer containing a graphene compound is between the first solid electrolyte layer and the second solid electrolyte layer. The layer containing a graphene compound has an ion conductivity and is configured to prevent a short circuit between the first electrode and the second electrode.

In each of the structures, the layer containing a graphene compound includes oxygen and a functional group.

In each of the structures, the layer containing a graphene compound includes oxygen, silicon, and a functional group.

In each of the structures, the layer containing a graphene compound includes a graphene oxide. Silicon is bonded to oxygen of the graphene oxide. The functional group is bonded to the silicon.

In each of the structures, an end portion of the graphene compound is terminated with ester and is fixed by chemically modified with an alkyl group.

One embodiment of the present invention can provide a lithium-ion secondary battery using a carbon-based material as a solid electrolyte. Another embodiment of the present invention can provide a power storage device using graphene oxide as a solid electrolyte and having desired ion conductivity and mechanical strength as well as preventing direct contact between electrodes in the power storage device. Another object is to achieve long-term reliability of a lithium-ion secondary battery.

One embodiment of the present invention can provide a lithium-ion secondary battery including a novel graphene oxide film. Another embodiment of the present invention can provide a novel power storage device and the like.

Another embodiment of the present invention can provide an all-solid lithium-ion secondary battery. When a battery is all solidified, an organic electrolyte solution is unnecessary and accordingly the problems such as liquid leakage and battery expansion due to vaporization of an organic electrolyte solution can be solved.

One embodiment of the present invention can provide a power storage device that can change in shape, in other words, a power storage device having flexibility. One embodiment of the present invention can provide a novel graphene oxide film that can resist change in shape in a power storage device having flexibility.

A battery pack or battery module means a part housed in a container and including one or a plurality of power storage devices provided with one or a plurality of protection circuits. The battery pack or battery module is used for not only mobile electronic devices but also medical equipment, next-generation clean energy vehicles such as hybrid electric vehicles (HEVs), electric vehicles (EVs), and plug-in hybrid electric vehicles (PHEVs), and the like.

Note that the description of these effects does not preclude the existence of other effects. One embodiment of the present invention does not necessarily achieve all the effects listed above. Other effects will be apparent from and can be derived from the description of the specification, the drawings, the claims, and the like.

### BRIEF DESCRIPTION OF DRAWINGS

FIGS. 1A to 1C are each an example of a cross-sectional view illustrating a power storage device of one embodiment of the present invention.

FIGS. 2A and 2B are each an example of a cross-sectional view illustrating a power storage device of one embodiment of the present invention.

FIGS. 3A to 3C each illustrate an example of a power storage device.

FIGS. 4A to 4D each illustrate an example of an electronic device of one embodiment of the present invention.

FIGS. 5A to 5C each illustrate an example of a vehicle of one embodiment of the present invention.

FIG. 6 is a cross-sectional view of a unit cell whose charge and discharge characteristics are measured.

FIGS. 7A and 7B are graphs showing experiment results of the charge and discharge characteristics.

FIGS. 8A and 8B are each a cross-sectional view of a unit cell whose ion conductivity is measured.

FIG. 9 is a graph showing experiment results of the ion conductivity.

FIGS. 10A and 10B each illustrate an equivalent circuit of a secondary battery in CC charging, and FIG. 10C shows the relation between secondary battery voltage and time and the relation between secondary battery charging current and time.

FIGS. 11A to 11C each illustrate an equivalent circuit of a secondary battery in CCCV charging, and FIG. 11D shows the relation between secondary battery voltage and time and the relation between secondary battery charging current and time.

FIG. 12 shows the relation between voltage and time and the relation between discharging current and time of a secondary battery in CC discharging.

FIG. 13 is a TEM observation image near electrodes of Example 2 which is one embodiment of the present invention.

FIG. 14 is a TEM observation image near electrodes of Example 3 which is one embodiment of the present invention.

### BEST MODE FOR CARRYING OUT THE INVENTION

Hereinafter, embodiments of the present invention will be described in detail with reference to the accompanying drawings. Note that one embodiment of the present invention is not limited to the description below, and it is easily understood by those skilled in the art that modes and details of the present invention can be modified in various ways. In addition, the present invention should not be construed as being limited to the description in the embodiments given below.

Note that in structures of the present invention described in this specification and the like, the same portions or portions having similar functions are denoted by common reference numerals in different drawings, and descriptions thereof are not repeated. The same hatching pattern is applied to portions having similar functions, and the portions are not especially denoted by reference numerals in some cases.

In this specification, flexibility refers to a property of an object being flexible and bendable. In other words, it is a property of an object that can be changed in form in response to an external force applied to the object, and elasticity or restorability to the former shape is not taken into consideration. A flexible power storage device can be changed in form in response to an external force. A flexible power storage device can be used with its shape fixed in a state of being changed in form, can be used while repeatedly changed in form, and can be used in a state of not changed in form. In this specification and the like, the inside of an exterior body refers to a region surrounded by the exterior body of a lithium-ion secondary battery, in which a structure such as a positive electrode, a negative electrode, an active material layer, and a separator, and an electrolyte solution are stored.

In this specification, modification refers to changing of a function or a property of a graphene oxide film by chemically changing the graphene oxide film. It may refer to addition of a functional group having a certain function or property.

The descriptions in embodiments of the present invention can be combined with each other as appropriate.

### Embodiment 1

In this embodiment, a lithium-ion secondary battery 100 of one embodiment of the present invention and a manufacturing method thereof will be described.

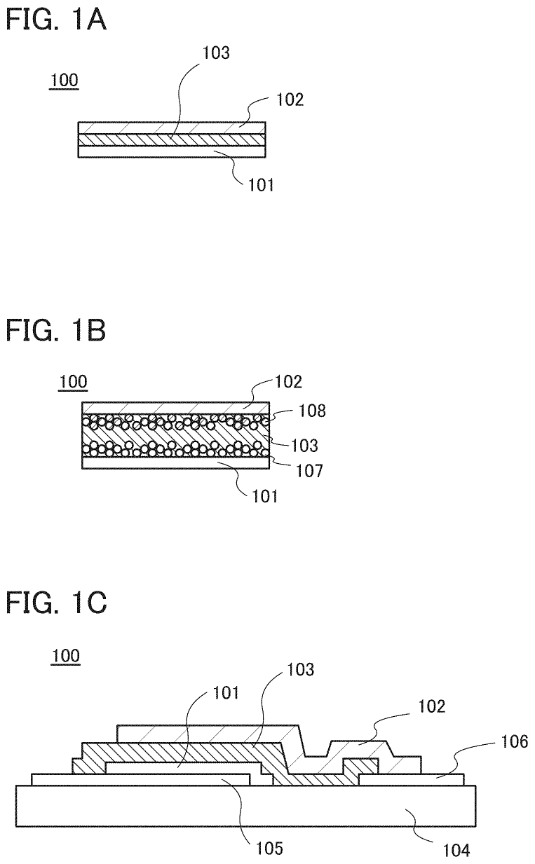

FIG. 1A shows a concept of the solid battery of one embodiment of the present invention and is an example using a layer 103 containing a graphene compound as a solid electrolyte between a positive electrode 101 and a negative electrode 102. As a carrier ion, a lithium ion, a sodium ion, a magnesium ion, and the like are given. In this example, a lithium ion is used for the secondary battery. For example, an organic solvent mixed with a graphene compound and a lithium salt is dried and made into a sheet form to be used as the layer 103 containing a graphene compound in FIG. 1A.

FIG. 1B is an example of a bulk-type all-solid battery including a positive electrode active material 107 in a particle state near the positive electrode 101 and a negative electrode active material 108 in a particle state near the negative electrode 102. The layer 103 containing the graphene compound is provided as a solid electrolyte to fill a space between the positive electrode active material 107 and the negative electrode active material 108. A space between the positive electrode 101 and the negative electrode 102 is filled with a plurality of kinds of particles by pressing.

As the positive electrode active material 107, a composite oxide with a layered rock-salt crystal structure, a composite oxide with a spinel crystal structure, or the like can be used. As the positive electrode active material, a polyanionic positive electrode material can be used, for example. Examples of the polyanionic positive electrode material are a material with an olivine crystal structure and a material with a NASICON structure. As the positive electrode active material, for example, a positive electrode material containing sulfur can be used.

As the positive electrode active material, various composite oxides can be used. For example, a compound such as LiFeO₂, LiCoO₂, LiNiO₂, LiMn₂O₄, Li₂MnO₃, Cr₂O₅, or MnO₂ can be used.

An example of a material with a layered rock-salt crystal structure includes a composite oxide represented by LiMO₂. The element M is preferably one or more elements selected from Co and Ni. LiCoO₂ is preferable because it has high capacity, high stability in the air, and relatively high thermal stability, for example. As the element M, one or more elements selected from Al and Mn may be included in addition to one or more elements selected from Co and Ni.

For example, LiNiₓMn_{y}Co_{z}O_{w} (x, y, and z are each 1/3 or a neighborhood thereof and w is 2 or a neighborhood thereof, for example) can be used. For example, LiNiₓMn_{y}Co_{z}O_{w} (x is 0.8 or a neighborhood thereof, y is 0.1 or a neighborhood thereof, z is 0.1 or a neighborhood thereof, and w is 2 or a neighborhood thereof, for example) can be used, For example, LiNiₓMn_{y}Co_{z}O_{w} (x is 0.5 or a neighborhood thereof, y is 0.3 or a neighborhood thereof, z is 0.2 or a neighborhood thereof, and w is 2 or a neighborhood thereof, for example) can be used. For example, LiNiₓMn_{y}Co_{z}O_{w} (x is 0.6 or a neighborhood thereof, y is 0.2 or a neighborhood thereof, z is 0.2 or a neighborhood thereof, and w is 2 or a neighborhood thereof, for example) can be used. For example, LiNiₓMn_{y}Co_{z}O_{w} (x is 0.4 or a neighborhood thereof, y is 0.4 or a neighborhood thereof, z is 0.2 or a neighborhood thereof, and w is 2 or a neighborhood thereof, for example) can be used.

A neighborhood is a value greater than 0.9 times and smaller than 1.1 times the value.

A material in which part of the transition metal and lithium included in the positive electrode active material is replaced with one or more elements selected from Fe, Co, Ni, Cr, Al, Mg, and the like, or a material in which the positive electrode active material is doped with one or more elements selected from Fe, Co, Ni, Cr, Al, Mg, and the like may be used for the positive electrode active material.

As the positive electrode active material, for example, a solid solution obtained by combining two or more composite oxides can be used. For example, a solid solution of LiNiₓMn_{y}Co_{z}O₂ (x, y z>0, x+y+z=1) and Li₂MnO₃ can be used as the positive electrode active material.

An example of a material with a spinel crystal structure includes a composite oxide represented by LiM₂O₄, it is preferable to contain Mn as the element M. For example, LiMn₂O₄ can be used. It is preferable that Ni be contained as the element M in addition to Mn because the discharge voltage and the energy density of the secondary battery are improved in some cases. It is preferable to add a small amount of lithium nickel oxide (LiNiO₂ or LiNi₁₋ₓMₓO₂ (M is Co, Al, or the like)) to a lithium-containing material with a spinel crystal structure which contains manganese, such as LiMn₂O₄, because the characteristics of the secondary battery can be improved.

The average diameter of primary particles of the positive electrode active material is preferably greater than or equal to 1 nm and less than or equal to 100 μm, further preferably greater than or equal to 50 nm and less than or equal to 50 μm, and still further preferably greater than or equal to 1 μm and less than or equal to 30 μm, for example. The specific surface area is preferably greater than or equal to 1 m²/g and less than or equal to 20 m²/g. The average diameter of secondary particles is preferably greater than or equal to 5 μm and less than or equal to 50 μm. Note that the average particle diameter can be measured with a particle diameter distribution analyzer or the like using a laser diffraction and scattering method or by observation with a scanning electron microscope (SEM) or a TEM. The specific surface area can be measured by a gas adsorption method.

A conductive material such as a carbon layer may be provided on the surface of the positive electrode active material. With the conductive material such as the carbon layer, conductivity of the electrode can be increased. For example, the positive electrode active material can be coated with a carbon layer by mixing a carbohydrate such as glucose at the time of baking the positive electrode active material. As the conductive material, graphene, multi-graphene, graphene oxide (GO), or reduced graphene oxide (RGO) can be used. Note that RGO refers to a compound obtained by reducing graphene oxide (GO), for example.

A layer containing an oxide and/or a fluoride may be provided on the surface of the positive electrode active material. The oxide may have a composition different from that of the positive electrode active material. The oxide may have the same composition as the positive electrode active material.

As the polyanionic positive electrode material, a complex oxide containing oxygen, an element X, a metal A, and a metal M. The metal M is one or more elements selected from Fe, Mn, Co, Ni, Ti, and Nb. The metal A is one or more elements selected from Li, Na, and Mg. The element X is one or more elements selected from S, P, Mo, W, As, and Si.

As an example of a material having an olivine crystal structure, a complex material (LiMPO₄ (general formula) (M is one or more of Fe(II), Mn(II), Co(II), and Ni(II))) can be given. Typical examples of the general formula LiMPO₄ are lithium compounds such as LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b≤a≤1, 0<a<1 and 0<b<1), LiFe_{c}Ni_{d}CoₑPO₄, LiFe_{c}Ni_{d}MnₑPO₄, LiNi_{c}Co_{d}MnₑPO₄ (c+d+e≤1, 0<c<1, 0<d<1, and 0<e<1), and LiFe_{f}Ni_{g}CoₕMnᵢPO₄ (f+g+h+i<1, 0<f<1, 0<g<0<h<1, and 0<i<1).

In particular, LiFePO₄ is preferable because it meets requirements with balance for the positive electrode active material, such as safety, stability, high capacity density, high potential, and the existence of lithium ions that can be extracted in initial oxidation (charging).

The average diameter of primary particles of the positive electrode active material having an olivine crystal structure is preferably greater than or equal to 1 nm and less than or equal to 20 μm, further preferably greater than or equal to 10 nm and less than or equal to 5 μm, and still further preferably greater than or equal to 50 nm and less than or equal to 2 μm, for example. The specific surface area is preferably greater than or equal to 1 m²/g and less than or equal to 20 m²/g. The average diameter of secondary particles is preferably greater than or equal to 5 μm and less than or equal to 50 μm.

Alternatively, a complex material such as Li(₂₋ⱼ)MSiO₄ (general formula) (M is one or more of Fe(II), Mn(II), Co(Il), and Ni(II); 0≤j≤2) may be used as the positive electrode active material. Typical examples of the general formula Li(₂₋ⱼ)MSiO₄ which can be used as a material are lithium compounds such as Li(₂₋ⱼ)FeSiO₄, Li(₂₋ⱼ)NiSiO₄, Li(₂₋ⱼ)CoSiO₄, Li(₂₋ⱼ)MnSiO₄, Li(₂₋ⱼ)FeₖNiₗSiO₄, Li(₂₋ⱼ)FeₖCoₗSiO₄, Li(₂₋ⱼ)FeₖMnₗSiO₄, Li(₂₋ⱼ)NiₖCoₗSiO₄, Li(₂₋ⱼ)NiₖMnₗSiO₄ (k+l≤1, 0<k<1 and 0<l<1), Li(₂₋ⱼ)FeₘNiₙCo_{q}SiO₄, Li(₂₋ⱼ)FeₘNiₙMn_{q}SiO₄, Li(₂₋ⱼ)NiₘCoₙMn_{q}SiO₄ (m+n+q≤1, 0<m<1, 0<n<1, and 0<q<1), and Li(₂₋ⱼ)FeᵣNiₛCoₜMnᵤSiO₄ (r+s+t+u≤1, 0<r−1, 0<s<1, 0<t<1, and 0<u<1).

A nasicon compound expressed by AₓM₂(XO₄)₃ (general formula) (A is Li, Na, or Mg, M is Fe, Mn, Ti, or Nb, X is S, P, Mo, W, As, or Si) can be used. Examples of the nasicon compound are Fe₂(MnO₄)₃, Fe₂(SO₄)₃, and Li₃Fe₂(PO₄)₃. A compound represented by Li₂MPO₄F, Li₂MP₂O₇, or Li₅MO₄ (general formula) (M is Fe or Mn) can be used as the positive electrode active material.

A perovskite fluoride such as NaFeF₃ and FeF₃, a metal chalcogenide (a sulfide, a selenide, or a telluride) such as TiS₂ and MoS₂, a manganese oxide, an organic sulfur compound, or the like can be used as the positive electrode active material.

A borate-based positive electrode material represented by a general formula LiMBO₃ (M is Fe(II), Mn(II), or Co(II)) can be used as the positive electrode active material.

Another example of the positive electrode active material is a lithium-manganese composite oxide that is represented by a composition formula LiₐMn_{b}M_{c}O_{d}. Here, the element M is preferably a metal element other than lithium and manganese, or silicon or phosphorus, more preferably nickel. In the case where the whole particle of a lithium-manganese composite oxide is measured, it is preferable to satisfy the following at the time of discharging: 0<a/(b−c)<2; c>0; and 0.26≤(b+c)/d<0.5. To increase the capacity, the lithium-manganese composite oxide preferably includes a region where the surface portion and the middle portion are different in the crystal structure, the crystal orientation, or the oxygen content. Such a lithium-manganese composite oxide preferably has 1.6≤a≤1.848; 0.19≤c/b≤0.935; and 2.5≤d≤3. It is particularly preferable to use a lithium-manganese composite oxide represented by a composition formula Li_{1.68}Mn_{0.8062}Ni_{0.318}O₃. In this specification and the like, a lithium-manganese composite oxide represented by a composition formula Li_{1.68}Mn_{0.8062}Ni_{0.318}O₃ refers to that formed at a ratio molar ratio) of the amounts of raw materials of Li₂CO₃:MnCO₃:NiO=0.84:0.8062:0.318. Although this lithium-manganese composite oxide is represented by a composition formula Li_{1.68}Mn_{0.8062}Ni_{0.318}O₃, the composition might deviate from this.

Note that the ratios of metal, silicon, phosphorus, and other elements to the total composition in the whole particle of a lithium-manganese composite oxide can be measured with, for example, an inductively coupled plasma mass spectrometer (ICP-MS). The ratio of oxygen to the total composition in the whole particle of a lithium-manganese composite oxide can be measured by, for example, energy dispersive X-ray spectroscopy (EDX). Alternatively, the ratio of oxygen to the total composition in the whole particle of a lithium-manganese composite oxide can be measured by ICP-MS combined with fusion gas analysis and valence evaluation of X-ray absorption fine structure (XAFS) analysis. Note that the lithium-manganese composite oxide is an oxide containing at least lithium and manganese, and. may contain at least one selected. from chromium, cobalt, aluminum, nickel, iron, magnesium, molybdenum, zinc, indium, gallium, copper, titanium, niobium, silicon, phosphorus, and the like.

In the case where carrier ions are alkali metal ions other than lithium ions, or alkaline-earth metal ions, a material containing an alkali metal (e.g., sodium or potassium) or an alkaline-earth metal (e.g., calcium, strontium, barium, beryllium, or magnesium) instead of lithium may be used as the positive electrode active material. For example, the positive electrode active material may be a layered oxide containing sodium.

As the positive electrode active material, for example, an oxide containing sodium, such as NaFeO₂, Na_{2/3}[Fe_{1/2}Mn_{1/2}]O₂, Na_{2/3}[Ni_{1/3}Mn_{2/3}]O₂, Na₂Fe₂(SO₄)₃, Na₂FePO₄F, NaMPO₄ (M is Fe(II), Mn(II), Co(II), or Ni(II)), Na₂FePO₄F, or Na₄Co₃(PO₄)₂P₂O₇ can be used.

As the positive electrode active material, a lithium-containing metal sulfide can be used. Examples of the lithium-containing metal sulfide are Li₂TiS₃ and Li₃NbS₄.

As a negative electrode active material 108, for example, an alloy-based material or a carbon-based material can be used.

For the negative electrode active material, an element which enables charge-discharge reactions by an alloying reaction and a dealloying reaction with lithium can be used. For example, a material containing at least one of silicon, tin, gallium, aluminum, germanium, lead, antimony, bismuth, silver, zinc, cadmium, indium, and the like can be used. Such elements have higher capacity than carbon. In particular, silicon has a significantly high theoretical capacity of 4200 mAh/g, For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, SbSn, and the like. Here, an element that enables charge-discharge reactions by an alloying reaction and a dealloying reaction with lithium, a compound containing the element, and the like may be referred to as an alloy-based material.

In this specification and the like, SiO refers, for example, to silicon monoxide. SiO can alternatively be expressed as SiOx. Here, x preferably has an approximate value of 1. For example, x is preferably 0.2 or more and 1.5 or less, and further preferably 0.3 or more and 1.2 or less.

As the carbon-based material, graphite, graphitizing carbon soft carbon), non-graphitizing carbon (hard carbon), a carbon nanotube, graphene, carbon black, or the like can be used.

Examples of graphite include artificial graphite and natural graphite. Examples of artificial graphite include meso-carbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of a lithium metal (higher than or equal to 0.05 V and lower than or equal to 0.3 V vs. Li/Li⁺) when lithium ions are intercalated into the graphite (while a lithium-graphite intercalation compound is generated). For this reason, a lithium-ion secondary battery can have a high operating voltage. In addition, graphite is preferred because of its advantages such as a relatively high capacity per unit volume, relatively small volume expansion, low cost, and higher level of safety than that of a lithium metal.

As the negative electrode active material, an oxide such as titanium dioxide (TiO₂), lithium titanium oxide (Li₄Ti₅O₁₂), lithium-graphite intercalation compound (LiₓC₆), niobium pentoxide (Nb₂O₅), tungsten dioxide (WO₂), or molybdenum dioxide (MoO₂) can be used.

As the negative electrode active material, Li₃₋ₓMₓN (M is Co, Ni, or Cu) with a Li₃N structure, which is a nitride containing lithium and a transition metal, can be used. For example, Li_{2.6}Co_{0.04}N is preferable because of high charge and discharge capacity (900 mAh/g and 1890 mAh/cm³),

A nitride containing lithium and. a transition metal is preferably used, in which case lithium ions are contained in the negative electrode active material and thus the negative electrode active material can be used in combination with a material for a positive electrode active material which does not contain lithium ions, such as V₂O₅ or Cr₃O₈. Note that even in the case of using a material including lithium ions as a positive electrode active material, the nitride including lithium and a transition metal can be used as the negative electrode active material by extracting lithium ions included in the positive electrode active material in advance.

Alternatively, a material which causes a conversion reaction can be used for the negative electrode active materials; for example, a transition metal oxide which does not form an alloy with lithium, such as cobalt oxide (CoO), nickel oxide (NiO), and iron oxide (FeO), may be used. Other examples of the material which causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

FIG. 1C shows an example of a thin-film-type all-solid battery and is a cross-sectional view of the lithium-ion secondary battery 100 of one embodiment of the present invention. FIG. 1C shows an example of forming a lithium-ion secondary battery after wiring electrodes 105 and 106 are formed over a substrate 104. As the substrate 104, a ceramic substrate, a glass substrate, a plastic substrate, a metal substrate, and the like can be used. The plastic substrate and metal substrate with small thicknesses have flexibility and thus are referred to as a flexible substrate or flexible film. When the flexible substrate or flexible film is used as the substrate 104, the lithium-ion secondary battery 100 can have flexibility.

The lithium-ion secondary battery 100 includes the positive electrode 101, the layer 103 containing a graphene compound, and the negative electrode 102. In this embodiment, the layer containing a graphene compound serves as a solid electrolyte.

A carrier ion such as a Li ion preferably moves fast in the layer containing a graphene compound. A chemically modified graphene compound is used to increase the interlayer distance, so that the movement speed of the carrier ion is increased. The layer containing a graphene compound may contain the carrier ion of lithium or the like in advance.

The chemically modified graphene compound may include two regions which differ in modification conditions.

Note that in this specification, the expression “modification conditions” refers to a state of modification for a graphene compound. The expression “two regions are in different modification states” refers to not only the case where the types of modification made on the two regions are different from each other but also the case where the same type of modification is made on the two regions and the strengths of the modification are different from each other. Also in the case where modification is made on one region and modification is not made on another region, the expression “the regions are in different modification states” is used. Thus, in some cases, two regions in different modification states differ in the kind of an atom or an atomic group introduced into a graphene compound, and even in the case where atoms or atomic groups of the same kind are introduced, the introduction amounts are different from each other.

Note that the modification of a graphene compound graphene oxide will be described in detail below.

A graphene compound may be used for a component other than the separator in one embodiment of the present invention. For example, a graphene compound can be used for at least one of the positive electrode current collector, positive electrode active material layer, negative electrode current collector, negative electrode active material layer, solid electrolyte, and exterior body. The positive electrode current collector and the positive electrode active material layer are collectively referred to as a positive electrode. The negative electrode current collector and the negative electrode active material layer are collectively referred to as a negative electrode.

As described later, when modification is performed, the structure and characteristics of a graphene compound can be selected from a wider range of alternatives. Moreover, a graphene compound has high mechanical strength and therefore can be used in a component of a flexible power storage device. Graphene compounds are described below.

Graphene has carbon atoms arranged in one atomic layer. A π bond exists between the carbon atoms. Graphene including two or more and one hundred or less layers is referred to as multilayer graphene in some cases. The length in the longitudinal direction or the length of the major axis in a plane in each of graphene and multilayer graphene is greater than or equal to 50 nm and less than or equal to 100 μm or greater than or equal to 800 nm and less than or equal to 50 μm.

In this specification and the like, a compound including graphene or multilayer graphene as a basic skeleton is referred to as a graphene compound. Graphene compounds include graphene and multilayer graphene.

Graphene compounds will be detailed below.

A graphene compound is, for example, a compound where graphene or multilayer graphene is modified with an atom other than carbon or an atomic group with an atom other than carbon. A graphene compound may be a compound where graphene or multilayer graphene is modified with an atomic group composed mainly of carbon, such as ether or ester. An atomic group that modifies graphene or multilayer graphene is referred to as a substituent, a functional group, a characteristic group, or the like in some cases. In this specification and the like, the term “being modified” means that an atom other than a carbon atom or an atomic group including an atom other than a carbon atom is introduced into graphene, multilayer graphene, a graphene compound, or graphene oxide (to be described later) by a substitution reaction, an addition reaction, or the other reaction.

Note that a front surface and a back surface of graphene may be modified with different atoms or different atomic groups. In multilayer graphene, multiple layers may be modified with different atoms or atomic groups.

An example of the above-described graphene modified with an atom or an atomic group is graphene or multilayer graphene that is modified with oxygen or a functional group containing oxygen. Examples of functional groups containing oxygen include an epoxy group, a carbonyl group such as a carboxyl group, and a hydroxyl group. A graphene compound modified with oxygen or a functional group containing oxygen is referred to as graphene oxide in some cases. In this specification, graphene oxides include multilayer graphene oxides.

As an example of an ether-modified graphene compound, a graphene compound having a structure represented by the following formula (200) can be given.

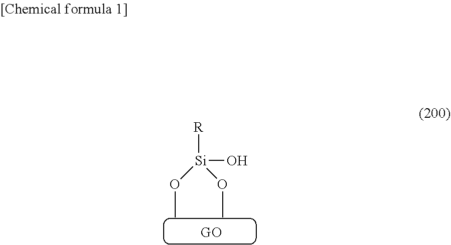

Note that in the formula (200), GO surrounded by a (in frame a square) represents graphene or graphene oxide, and R represents a substituted or unsubstituted chain group having at least two ether bonds.

As an example of an ether-modified graphene compound, a graphene compound having a structure represented by the following formula (201) can be given.

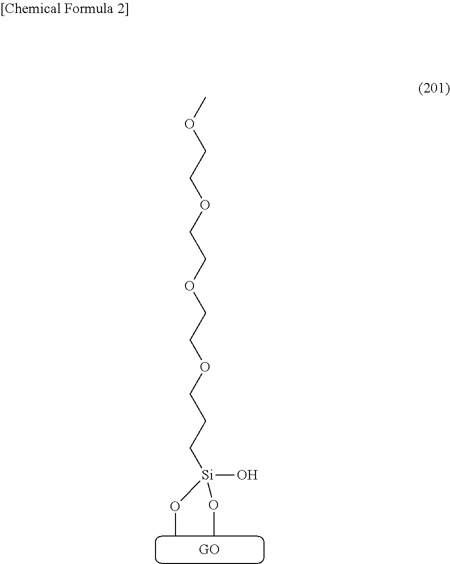 [SMILES: COCCOCCOCCOCCC[Si](O)(OC)OC]

Note that in the formula (201), GO surrounded by a frame (in a square) represents graphene or graphene oxide.

As an example of modification of graphene oxide, silylation of graphene oxide is described. First, in a nitrogen atmosphere, graphene oxide is put in a container, n-butylamine (C₄H₉NH₂) is added to the container, and stirring is performed for one hour with the temperature kept at 60° C. Then, toluene is added to the container, alkyltrichlorosilane is added thereto as a silylating agent, and stirring is performed in a nitrogen atmosphere for five hours with the temperature kept at 60° C. Then, toluene is further added to the container, and the resulting solution is suction-filtrated to give a solid powder. The powder is dispersed in ethanol, and the resulting solution is suction-filtered to give a solid powder. The powder is dispersed in acetone, and the resulting solution is suction-filtered to give a solid powder. A liquid of the solid powder is vaporized to give silylated graphene oxide.

The obtained graphene compound has a structure represented by the following formula (202).

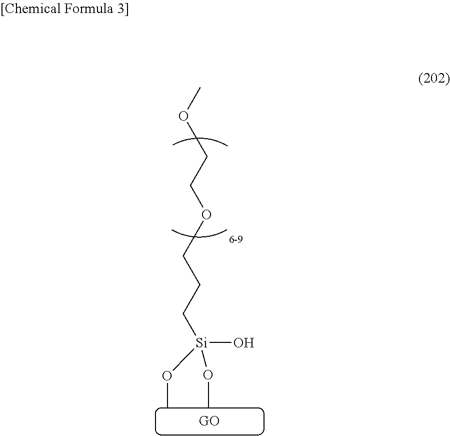

Note that in the formula (202), GO surrounded by a frame (in a square) represents graphene or graphene oxide.

In a formula (202), R represents a substituted or unsubstituted chain group having at least two ether bonds. Note that R may have a branched structure. Furthermore, GO surrounded by a frame (in a square) represents graphene or graphene oxide. There is no particular limitation on the molecular weight or molecular structure of graphene in the graphene compound of one embodiment of the present invention, and graphene in any size can be used. Accordingly, it is difficult to specify a molecular structure of the graphene compound of one embodiment of the present invention in detail and fully represent the molecular structure of the graphene compound of one embodiment of the present invention. Thus, the chemically modified graphene compound of one embodiment of the present invention might be practically specified by describing a formation method; for example, a graphene compound chemically modified with a silylating agent that has a substituted or unsubstituted group having at least two ether bonds. In addition, it is impossible or impractical to specify the chemically modified graphene compound of one embodiment of the present invention without describing a formation method, in some cases. Furthermore, although GO and Si (silicon) are fixed in the shape of a GO layer with two Si—O bonds in the above formula, the number of the Si—O bonds may be one or three. The bond is not limited to the Si—O bond, and another bond may be used to fix GO and Si.

As an example of an ester-modified graphene compound, a graphene compound having a structure represented by the following formula (203) can be given.

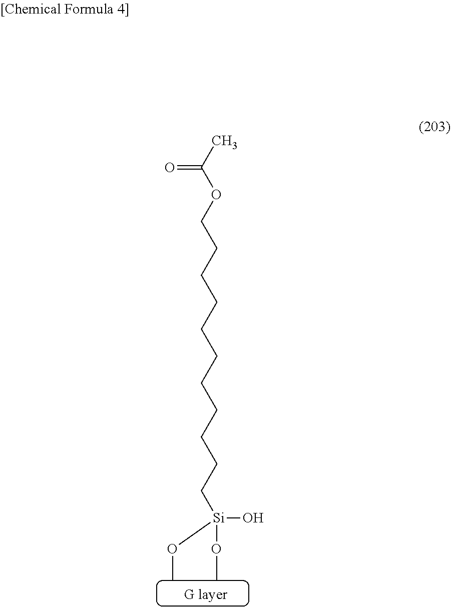 [SMILES: CO[Si](O)(CCCCCCCCCCCOC(C)=O)OC]

As an example of an ether-modified and ester-modified graphene compound, a graphene compound having a structure represented by the following formula (204) can be given.

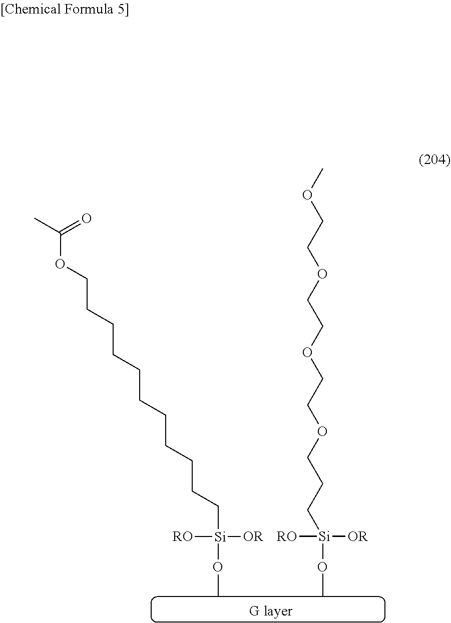

Whether the compound is chemically modified can be determined by the existence of a peak that is probably derived from a group having an ether bond in FT-IR analysis. For example, in the FT-IR analysis, attenuated total reflection (ATR) is performed using Nicolet NEXUS 670 produced by Thermo Fisher Scientific Inc.

Note that silylation is described as an example of the modification performed on graphene oxide, but silylation is not limited to the modification performed on graphene oxide. In some cases, silylation can be performed on graphene that is not oxidized. Furthermore, modification in this embodiment is not limited to the modification performed on graphene oxide and can be performed on graphene compounds in some cases. The modification is not limited to silylation, and silylation is not limited. to the above-described method.

The modification is not limited to introduction of an atom or an atomic group of one kind, and the modification of two or more types may be performed to introduce atoms or atomic groups of two or more kinds. As modification, a reaction of adding hydrogen, a halogen atom, a hydrocarbon group, an aromatic series hydrocarbon group, and/or a heterocyclic compound group may be performed. As a reaction of introducing an atomic group to graphene, an addition reaction, a substitution reaction, or the like are given. Alternatively, a Friedel-Crafts reaction, a Bingel reaction, or the like may be performed. A radical addition reaction may be performed on graphene, and a ring may be formed between graphene and an atomic group by a cycloaddition reaction.

By introducing a given atomic group to a graphene compound, the physical property of the graphene compound can be changed. Therefore, by performing desirable modification in accordance with the application of a graphene compound, a desired property of the graphene compound can be exhibited intentionally.

A formation method example of graphene oxide is described below. Graphene oxide can be obtained by oxidizing the aforementioned graphene or multilayer graphene. Alternatively, graphene oxide can be obtained by being separated from graphite oxide. Graphite oxide can be formed by oxidizing graphite. The graphene oxide may be further modified with the above-mentioned atom or atomic group.

A compound that can be obtained by reducing graphene oxide is referred to as reduced graphene oxide (RGO) in some cases. In RGO, in some cases, all oxygen atoms contained in the graphene oxide are not extracted and part of them remains in a state of bonded oxygen or atomic group containing oxygen. In some cases, RGO includes a functional group, e.g., an epoxy group, a carbonyl group such as a carboxyl group, or a hydroxyl group.

A graphene compound may have a sheet-like shape where a plurality of graphene compounds partly overlap with each other. Such a graphene compound is referred to as a graphene compound sheet in some cases. The graphene compound sheet has, for example, an area with a thickness lamer than or equal to 0.33 nm and smaller than or equal to 10 mm, preferably larger than or equal to 0.34 nm and smaller than or equal to 10 μm. The graphene compound sheet may be modified with an atom other than carbon, an atomic group containing an atom other than carbon, an atomic group composed mainly of carbon such as ether or ester. A plurality of layers in the graphene compound sheet may be modified with different atoms or atomic groups.

A graphene compound may have a five-membered ring composed of carbon atoms or a poly-membered ring that is a seven or more-membered ring composed of carbon atoms, in addition to a six-membered ring composed of carbon atoms. In the neighborhood of a poly-membered ring which is a seven- or more-membered ring, a region through which a lithium ion can pass may be generated.

A plurality of graphene compounds may be gathered to form a sheet-like shape. A graphene compound has a planar shape, thereby enabling surface contact.

In some cases, a graphene compound has high conductivity even when it is thin. The contact area between graphene compounds or between a graphene compound and an active material can be increased by surface contact. Thus, a conductive path can be efficiently formed even with a small amount per unit volume of the graphene compound.

In contrast, a graphene compound may also be used as an insulator. For example, a graphene compound sheet can be used as a sheet-like insulator. Graphene oxide, for example, has a higher insulation property than a graphene compound that is not oxidized, in some cases. A graphene compound modified with an atomic group may have an improved insulation property, depending on the type of the modifying atomic group.

A graphene compound in this specification and the like may include a precursor of graphene. The precursor of graphene refers to a substance used for forming graphene. The precursor of graphene may contain the above-described graphene oxide, graphite oxide, or the like.

Graphene containing an alkali metal or an element other than carbon, such as oxygen, is referred to as a graphene analog in some cases. In this specification and the like, graphene compounds include graphene analogs.

A graphene compound in this specification and the like may include an atom, an atomic group, and ions of them between the layers. The physical properties, such as electric conductivity and ion conductivity, of a graphene compound sometimes change when an atom, an atomic group, and ions of them exist between layers of the compound. In addition, a distance between the layers is increased in some cases.

A graphene compound has excellent electrical characteristics of high conductivity and excellent physical properties of high flexibility and. high mechanical strength in some cases. A modified graphene compound can have extremely low conductivity and serve as an insulator depending on the type of the modification. A graphene compound has a planar shape. A Graphene compound enables low-resistance surface contact.

Although the lithium-ion secondary battery 100 shown in FIG. 1A can be used by itself, for usage convenience, one or a plurality of lithium secondary batteries is preferably stored in a container together with circuits (e.g., a charge and. discharge control circuit, a protection circuit). The stored battery is also referred to as a battery pack. For heat insulation, a heat insulator such as glass wool may be provided in the battery pack.

### Embodiment 2

In this embodiment, an example of a lithium-ion secondary battery using a plurality of kinds of solid electrolyte layers as a multilayer structure is shown.

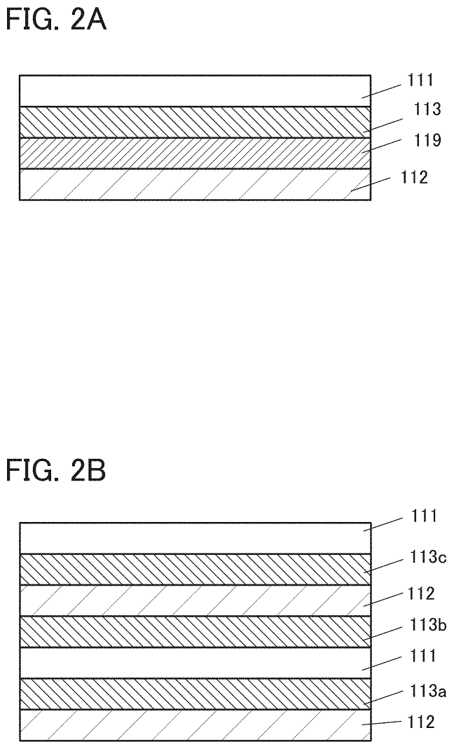

FIG. 2A shows an example in which a solid electrolyte layer using a polymer-based solid electrolyte such as polyethylene oxide (PEO) and a solid electrolyte layer using a layer containing a graphene compound are used.

When a solid electrolyte layer using a layer 113 containing a graphene compound is in contact with a current collector 111 serving as a positive electrode, there are portions at the interface between the current collector and the layer containing a graphene compound where the graphene compound and the current collector are in contact with each other.

In order to reduce the contact resistance, a polymer-based solid electrolyte, for example, a solid electrolyte layer 119 containing PEO is provided between a current collector 112 including a negative electrode active material layer serving as a negative electrode and the layer 113 containing a graphene compound.

Although two different electrolyte layers are stacked in the example of FIG. 2A, three or more layers may be stacked without particular limitation. For example, a three-layered structure in which a layer containing a graphene compound is sandwiched between two PEO layers may be used.

FIG. 2B shows an example in which a positive electrode and a negative electrode are repeatedly stacked to increase the capacity of a secondary battery.

The stacked structure shown in FIG. 2B includes three layers 113a, 113b, and 113c containing a graphene compound. In the stacked structure shown in FIG. 2B, the current collector 112 including a negative electrode active material layer and serving as a negative electrode, the layer 113a containing a graphene compound, the current collector 111 including a positive electrode active material layer and serving as a positive electrode, the layer 113b containing a graphene compound, the current collector 112 including a negative electrode active material layer and serving as a negative electrode, the layer 113c containing a graphene compound, and the current collector 111 including a positive electrode active material layer and serving as a positive electrode are stacked in this order. In this structure, there are only two couples of the current collector 111 including a positive electrode active material layer and serving as a positive electrode and the current collector 112 including a negative electrode active material layer serving as a negative electrode. Thus, the secondary battery has a large capacity per volume.

In the stacked structure shown in FIG. 2B, a solid electrolyte layer containing a polymer-based solid electrolyte may be provided between the current collector 112 including a negative electrode active material layer serving as a negative electrode and the layer 113a containing a graphene compound.

This embodiment can be freely combined with Embodiment 1.

### Embodiment 3

In this embodiment, a graphene compound used for a solid electrolyte is described. In addition, a method for forming a graphene compound by chemical modification is described. The graphene compound formed according to one embodiment of the present invention has a function of conducting metal ions such as lithium, sodium, magnesium, and calcium and thus can be used for a solid electrolyte of a lithium-ion secondary battery, for example. However, one embodiment of the present invention is not limited thereto.

Although graphene oxide has relatively low electron conductivity, it has low reduction resistance and thus is easily reduced to RGO having high electron conductivity. In order to provide graphene oxide or graphene with an insulating property, chemical modification is preferably used. For example, graphene oxide or graphene may be chemically modified with a molecule having an alkyl chain that has a relatively large number of carbon atoms. When both surfaces of a sheet-like graphene oxide are chemically modified with a compound having a long chain alkyl group, the distance between a plurality of sheets of graphene oxide is increased and electronic conduction is suppressed because the alkyl chain contains a functional group having low electron conductivity, so that an insulating property can be provided.

However, an alkyl group is a non-polar functional group and has a low affinity for lithium ions which cause a battery reaction in a lithium-ion secondary battery. Thus, when graphene is chemically modified with a compound having a long chain alkyl group, the transfer of lithium ions is inhibited and accordingly a battery reaction is inhibited. Accordingly, a lithium-ion secondary battery including a graphene compound chemically modified with a compound having a long chain alkyl group as a solid electrolyte has poor output characteristics.

In view of the above, the graphene compound of one embodiment of the present invention has both an insulating property and an affinity for lithium ions. For example, it is preferable that the graphene compound be chemically modified to have a functional group such as an ester group or a carboxyl group. The ester group and the carboxyl group are classified into a hydrophilic group. The ester group and the carboxyl group each have an affinity for lithium ions owing to its polarity and contribute to the dissociation of a lithium salt and the transfer of lithium ions. Furthermore, when the graphene compound is used for a solid electrolyte of a lithium-ion secondary battery, the number of ester groups and carboxyl groups in a functional group of the graphene compound is preferably large because the mobility of lithium ions is improved.

However, as the number of ester groups or carboxyl groups increases, the molecular weight of the graphene compound becomes large and the graphene compound becomes unlikely to be dissolved in a solvent; thus, reactivity of graphene or graphene oxide when chemically modified is reduced in some cases. In addition, as the number of ester groups increases, a hydrolysis reaction is likely to occur in some cases. Therefore, the number of ester groups or carboxyl groups is preferably 1 to 10.

The graphene compound of one embodiment of the present invention has, when used for a solid electrolyte, higher heat resistance than a polymer electrolyte. High durability is especially important for a lithium-ion secondary battery to prevent a serious accident such as firing or explosion caused by an unexpected reaction due to damage to a component in the battery. Low heat resistance of its component is a major problem when a lithium-ion secondary battery is used in a severe environment, e.g., in a car. The graphene compound of one embodiment of the present invention can withstand a high-temperature environment because of its high heat resistance. Thus, the graphene compound of one embodiment of the present invention is suitably used for the component of the lithium-ion secondary battery, specifically a solid electrolyte.

An example of graphene oxide is represented by a structural formula (300). Although the structural formula (300) shows an example in which a graphene layer (G layer) has an epoxy group, a hydroxy group, and a carboxy group, the kind and the number of functional groups of the graphene oxide are not limited to those of this example.

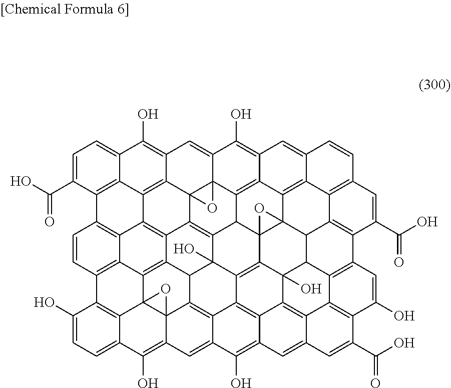

A simplified structure of graphene oxide is represented by a general formula (G3). In the general formula (G3), “G layer” represents a graphene layer. The graphene layer is a sheet-like layer of carbon atoms bonded to each other. The graphene layer may be either a single layer or a multilayer and may include defects or functional groups. Hereinafter, the graphene oxide is described with the general formula (G3). Although the general formula (G3) shows an example in which the graphene layer has two hydroxy groups, the kind and the number of functional groups of the graphene layer of the present invention are not limited to those of this example.

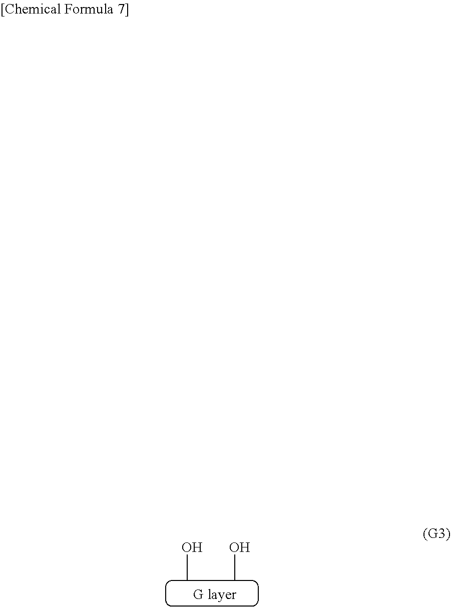

A formation method example of graphene oxide is described below. Graphene oxide can be obtained by oxidizing the aforementioned graphene or multilayer graphene. Alternatively, graphene oxide can be obtained by being separated from graphite oxide. Graphite oxide can be formed by oxidizing graphite. The graphene oxide may be further chemically modified with the above-described atom or atomic group.

### <Chemically Modified Graphene Compound>

Next, the chemically modified graphene compound is described. A graphene compound formed by a formation method of one embodiment of the present invention can be used for a solid electrolyte of a lithium-ion secondary battery, for example. In that case, the graphene compound needs to have an insulating property to prevent a short circuit between a positive electrode and a negative electrode. Note that the graphene compound of one embodiment of the present invention has conductivity to metal ions such as sodium, magnesium, and calcium in addition to lithium; thus, the graphene compound of one embodiment of the present invention can be used for applications other than a lithium-ion secondary battery. In this embodiment, a power storage device including a lithium ion, which is a typical example of such metal ions, as a carrier is described; the description can also be used for a power storage device including another metal ion as a carrier.

Pure graphene is known to have high electron conductivity, and pure graphene by itself cannot be used for a solid electrolyte of a lithium-ion secondary battery. Although graphene oxide has relatively low electron conductivity, it has low reduction resistance and thus is easily reduced to RGO having high electron conductivity. In order to provide graphene oxide or graphene with an insulating property stably, chemical modification is preferably used. For example, graphene oxide or graphene may be chemically modified with a molecule having an alkyl chain that has a relatively large number of carbon atoms. When both surfaces of a sheet-like graphene oxide are chemically modified with a compound having a long chain alkyl group, the distance between a plurality of sheets of graphene oxide is increased and electronic conduction is suppressed because the alkyl chain contains a functional group having low electron conductivity, so that an insulating property can be provided.

However, an alkyl group is a non-polar functional group and has a low affinity for lithium ions which cause a battery reaction in a lithium-ion secondary battery. Thus, when graphene is chemically modified with a compound having a long chain alkyl group, the transfer of lithium ions is inhibited and accordingly a battery reaction is inhibited. Accordingly, a lithium-ion secondary battery including a graphene compound chemically modified with a compound having a long chain alkyl group as a solid electrolyte has poor output characteristics.

In view of the above, the graphene compound of one embodiment of the present invention has both an insulating property and an affinity for lithium ions. For example, it is preferable that the graphene compound be chemically modified to have a functional group such as an ester group or a carboxyl group. The ester group and the carboxyl group are classified into a hydrophilic group. The ester group and the carboxyl group each have an affinity for lithium ions owing to its polarity and contribute to the dissociation of a lithium salt and the transfer of lithium ions. Furthermore, when the graphene compound is used for a solid electrolyte of a lithium-ion secondary battery, the number of ester groups and carboxyl groups in a functional group of the graphene compound is preferably large because the mobility of lithium ions is improved.

However, as the number of ester groups or carboxyl groups increases, the molecular weight of the graphene compound becomes large and the graphene compound becomes unlikely to be dissolved in a solvent; thus, reactivity of graphene or graphene oxide when chemically modified is reduced in some cases. In addition, as the number of ester groups increases, a hydrolysis reaction is likely to occur in some cases. Therefore, the number of ester groups or carboxyl groups is preferably 1 to 10.

Another embodiment of the present invention is a graphene compound represented by the following general formula (G1) or (G2).

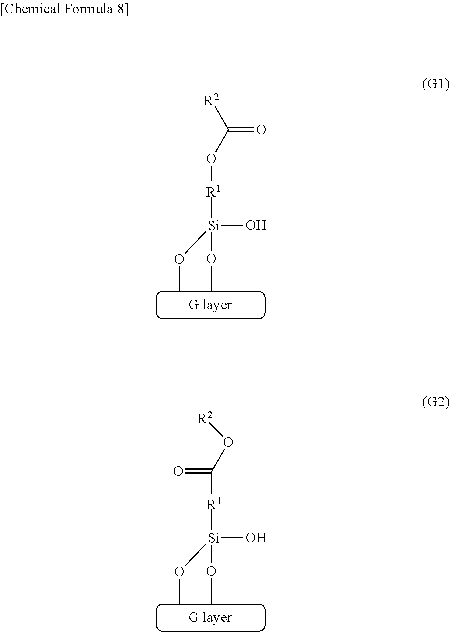

In each of the general formulas (G1) and (G2), G layer represents a graphene layer.

In each of the general formulas (G1) and (G2), R¹ represents a substituted or unsubstituted alkyl group and may be branched. R² represents hydrogen or a substituted or unsubstituted alkyl group and may be branched. The general formula (G1) is classified into ester because the general formula (G1) has an ester group. In the case where R² in the general formula (G2) is an alkyl group, the general formula (G2) is classified into ester because the general formula (G2) has an ester group. In the case where R² in the general formula (G2) is hydrogen, the general formula (G2) is classified into carboxylic acids because the general formula (G2) has a carboxyl group.

Note that substitution in the general formula (G1) or (G2) is preferably substitution by a substituent such as an alkyl group having 1 to 6 carbon atoms, a methyl group, an ethyl group, an n-propyl group, an iso-propyl group, a sec-butyl group, a tart-butyl group, an n-pentyl group, or an n-hexyl group, an aryl group having 6 to 10 carbon atoms, e.g., a phenyl group, an o-tolyl group, an m-tolyl group, a p-tolyl group, a 1-naphthyl group, or a 2-naphthyl group, fluorine, or trifluoromethane.

Alternatively, R¹ is preferably a substituted or unsubstituted alkyl group having 1 to 20 carbon atoms. R² is preferably hydrogen or a substituted or unsubstituted alkyl group having 1 to 20 carbon atoms. Interlayer distance in a chemically modified graphene compound may be larger than that in graphene or graphene oxide. As the interlayer distance increases, the electron conductivity becomes low; therefore, the chemically modified graphene compound is favorably used as a solid electrolyte to prevent a short circuit (an internal short circuit) between a positive electrode and a negative electrode. Alternatively, R¹ and R² may be selected as appropriate so that the interlayer distance with which desired electron conductivity is obtained is set.

Alternatively, R¹ is preferably a substituted or unsubstituted alkyl group having 1 to 11 carbon atoms. Alternatively, R² is preferably a substituted or unsubstituted alkyl group having 1 to 11 carbon atoms. In terms of dispersibility in a solvent and ionic conductivity, the graphene compound of the present invention is preferable as a material for a solid electrolyte of a lithium-ion secondary battery.

There is no particular limitation on the molecular weight or molecular structure of graphene in the graphene compound of one embodiment of the present invention, and graphene in any size can be used. Accordingly, it is impossible to specify a molecular structure of the graphene compound of one embodiment of the present invention in detail and fully represent the molecular structure of the graphene compound of one embodiment of the present invention. Thus, the chemically modified graphene compound of one embodiment of the present invention might be practically specified by describing a formation method; for example, a graphene compound chemically modified with a silicon compound that has a substituted or unsubstituted group having one or more ester groups or carboxyl groups. In addition, it is impossible or impractical to specify the chemically modified graphene compound of one embodiment of the present invention without describing a formation method, in some cases. Furthermore, although GO and Si are fixed in the shape of a GO layer with two Si—O bonds in the above formula, the number of the Si—O bonds may be one or three. The bond is not limited to the Si—O bond, and another bond may be used. The bond is not limited to the Si—O bond, and another bond may be used. A hydroxy group or an alkoxy group may be bonded to a Si atom that is not bonded to the graphene layer.

### <Chemical Modification>

Next, a method for chemically modifying graphene or graphene oxide is described using the following synthesis schemes (A-1) and (A-2).

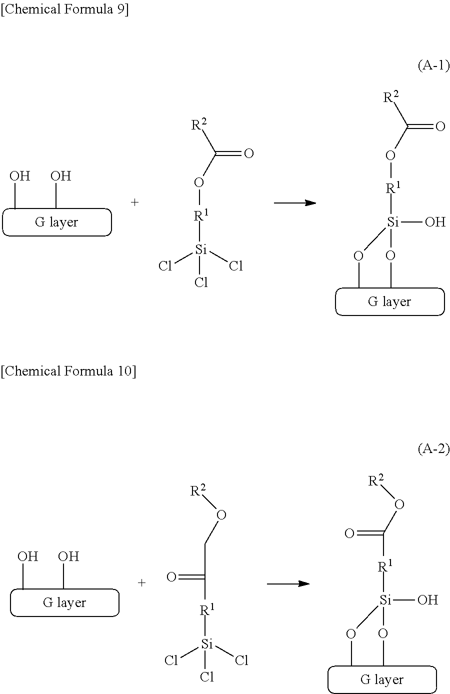

In each of the synthesis schemes (A-1) and (A-2), “G layer” represents a graphene layer.

As shown in each of the synthesis schemes (A-1) and (A-2), a silicon compound having one or more ester groups or carboxyl groups is reacted with graphene or graphene oxide in the presence of a Lewis base, whereby a chemically modified objective compound can be obtained. Such a reaction is referred to as silylation in some cases.

Silylation means the substitution of a silicon atom for a hydrogen atom in a hydroxy group, an amino group, a carboxyl group, an amide group, a mercapto group, or the like. A silicon compound used for silylation is referred to as a silylating agent in some cases.

As the Lewis base, alkylamine or a heterocyclic aromatic compound can be used. Specifically, one or more of butylamine, pentylamine, hexylamine, diethylamine, dipropylamine, dibutylamine, triethylamine, tripropylamine, and pyridine can be used.

In addition, the reaction is preferably performed under an inert gas atmosphere of nitrogen or a rare gas such as argon. The atmosphere of nitrogen or argon is preferable because hydrolysis of the silicon compound, oxidation of the Lewis base, or the like can be prevented. The atmosphere of the reaction is not limited to nitrogen or argon and may be an air atmosphere, for example.

In each of the synthesis schemes (A-1) and (A-2), R¹ represents a substituted or unsubstituted alkyl group and may be branched. R² represents hydrogen or a substituted or unsubstituted alkyl group and may be branched.

Alternatively, R¹ is preferably a substituted or unsubstituted alkyl group having 1 to 20 carbon atoms. R² is preferably hydrogen or a substituted or unsubstituted alkyl group having 1 to 20 carbon atoms.

Alternatively, is preferably a substituted or unsubstituted alkyl group having 1 to 11 carbon atoms. Alternatively, R² is preferably a substituted or unsubstituted alkyl group having 1 to 11 carbon atoms.

Examples of a Lewis base that can be used in each of the synthesis schemes (A-1) and (A-2) include, but are not limited to, organic bases such as butylamine, pentylamine, hexylamine, diethylamine, dipropylamine, dibutylamine, triethylamine, tripropylamine, and pyridine. Note that the Lewis base which can be used is not limited thereto.

Examples of a solvent that can be used in each of the synthesis schemes (A-1) and (A-2) include, but are not limited to, aromatic hydrocarbons such as toluene, xylene, and mesitylene; hydrocarbons such as hexane and heptane; and ether such as ethylene glycol dimethyl ether. However, the solvent that can be used is not limited to these solvents. It is particularly preferable to use primary amine as a Lewis base and an aromatic hydrocarbon as a solvent.

Instead of the silicon compound shown in each of the synthesis schemes (A-1) and (A-2) an agent having a trialkoxysilyl group may be used. However, the present invention is not limited thereto.

### <Specific Example>

Here, examples of a silicon compound that has a chain group having one or more ester groups or carboxyl groups are shown below. With the use of any of such silicon compounds, a graphene compound chemically modified with a chain group having one or more ester groups or carboxyl groups can be formed. Compounds 100 to 149 and compounds 156 to 161, which have ester groups, are classified into ester. Compounds 150 to 155, which have carboxyl groups, are classified into carboxylic acids.

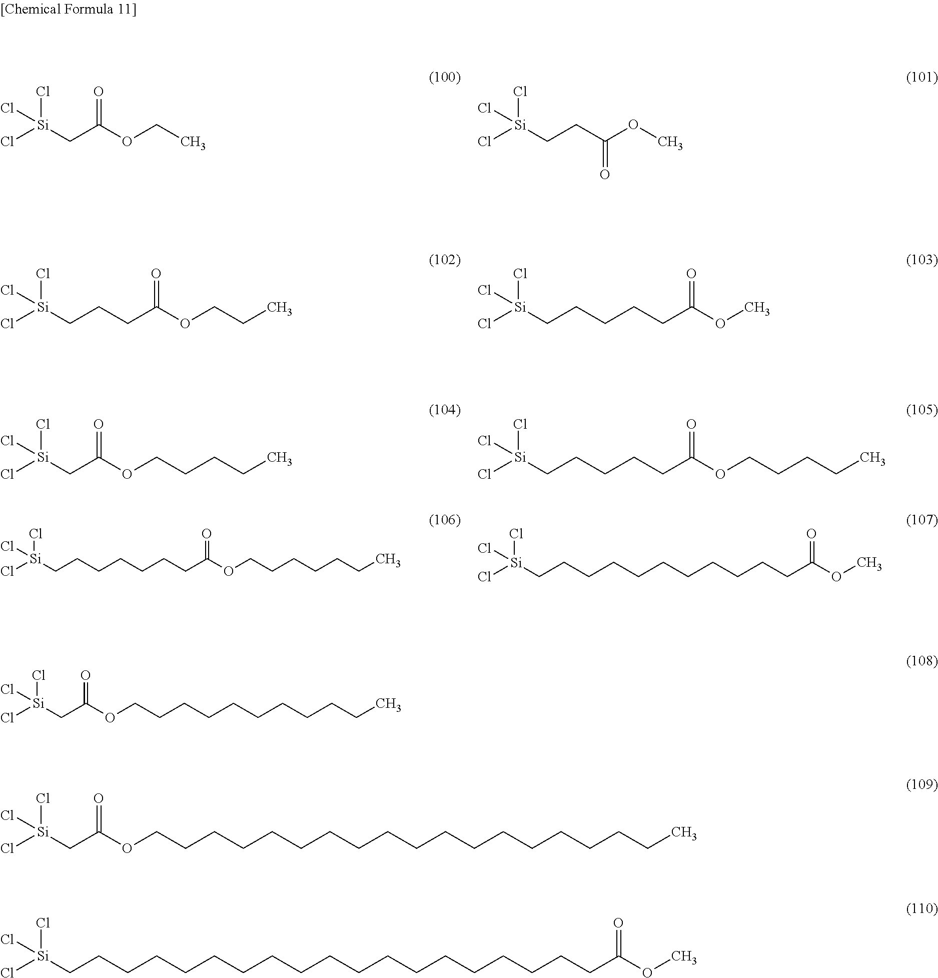

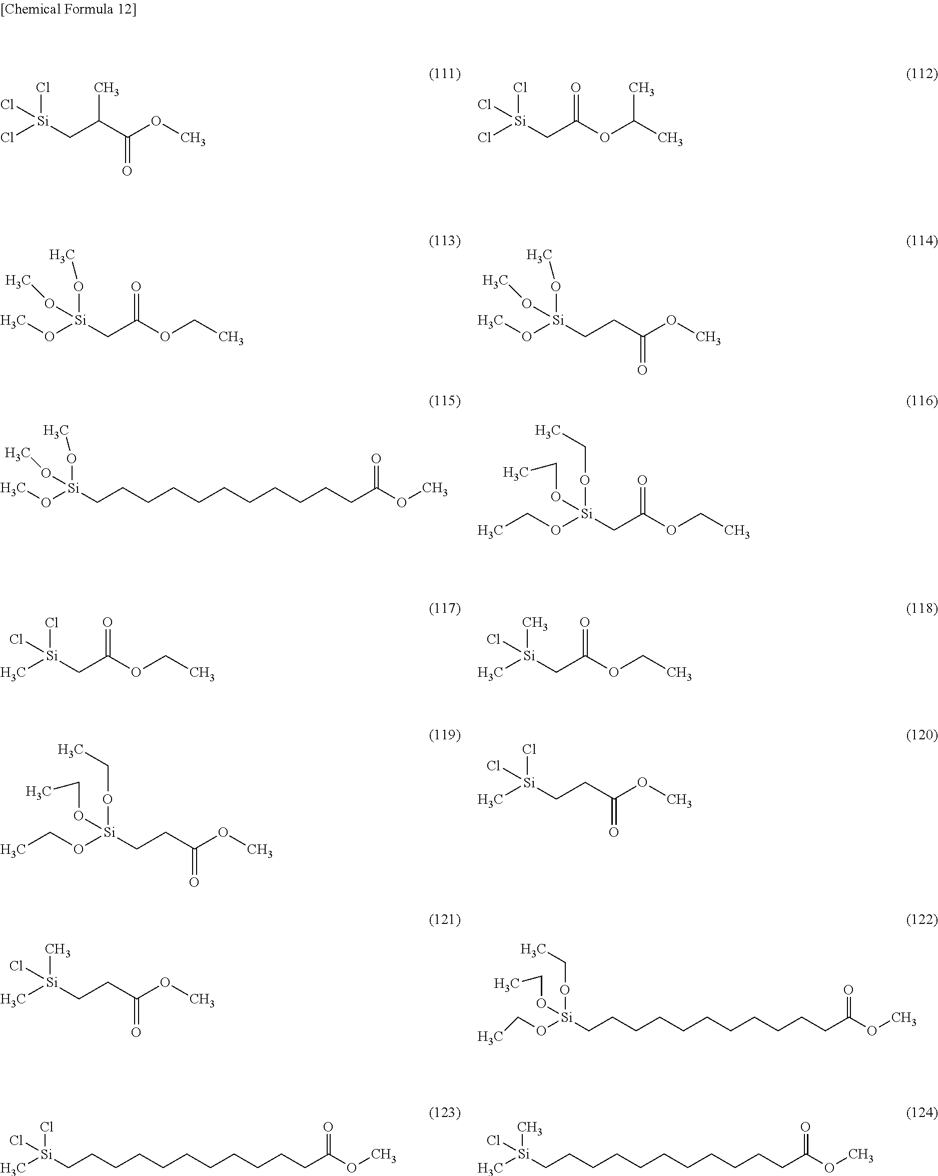

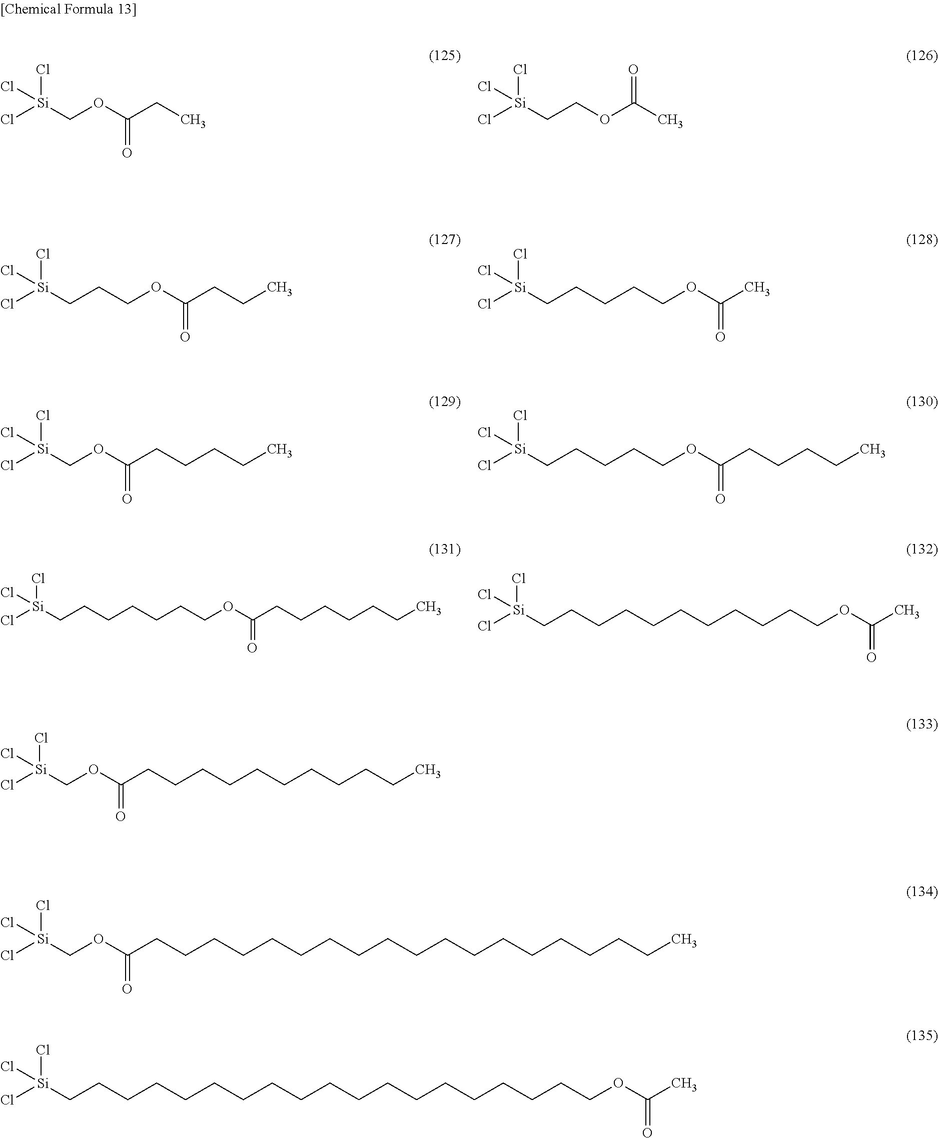

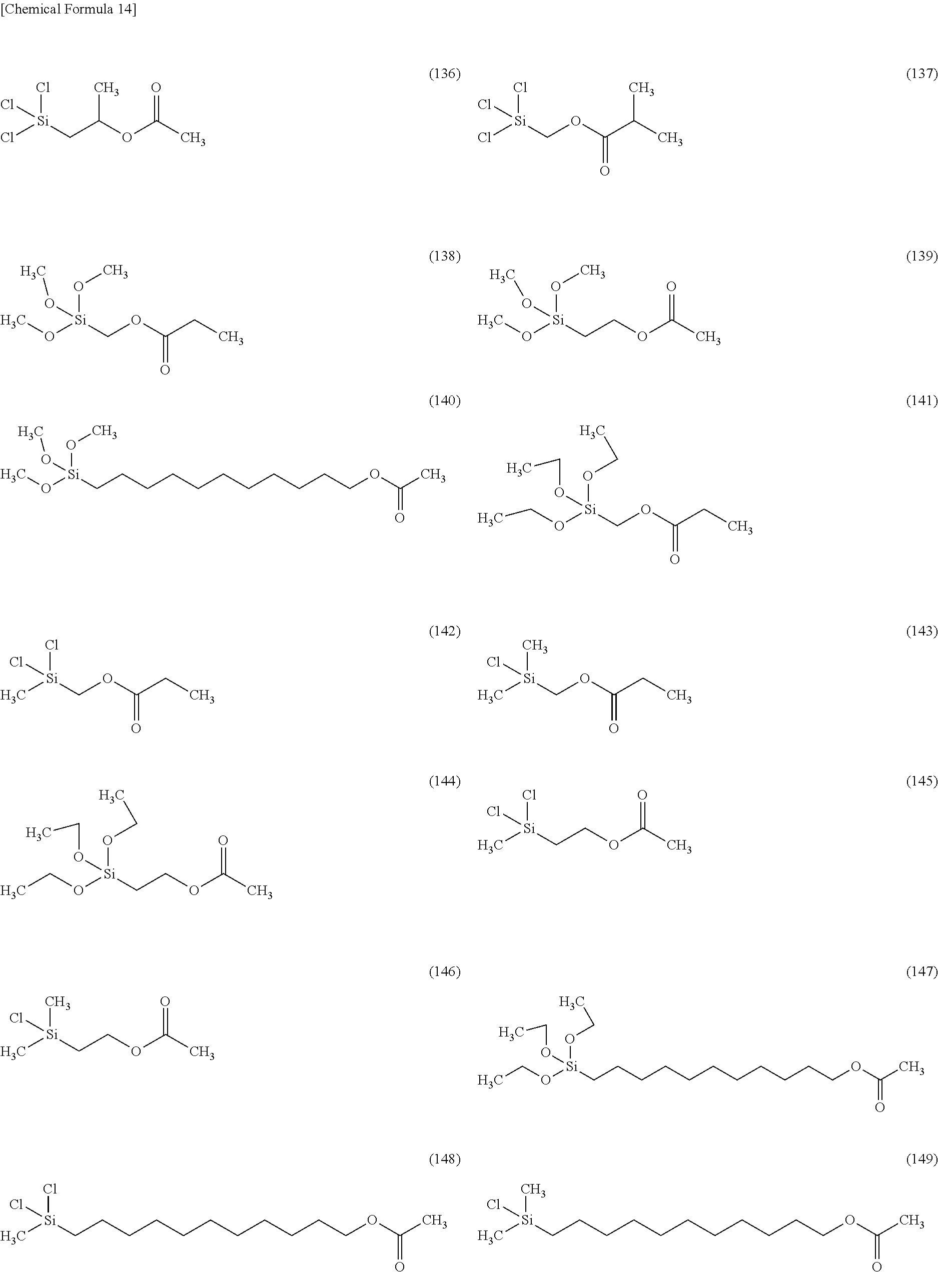

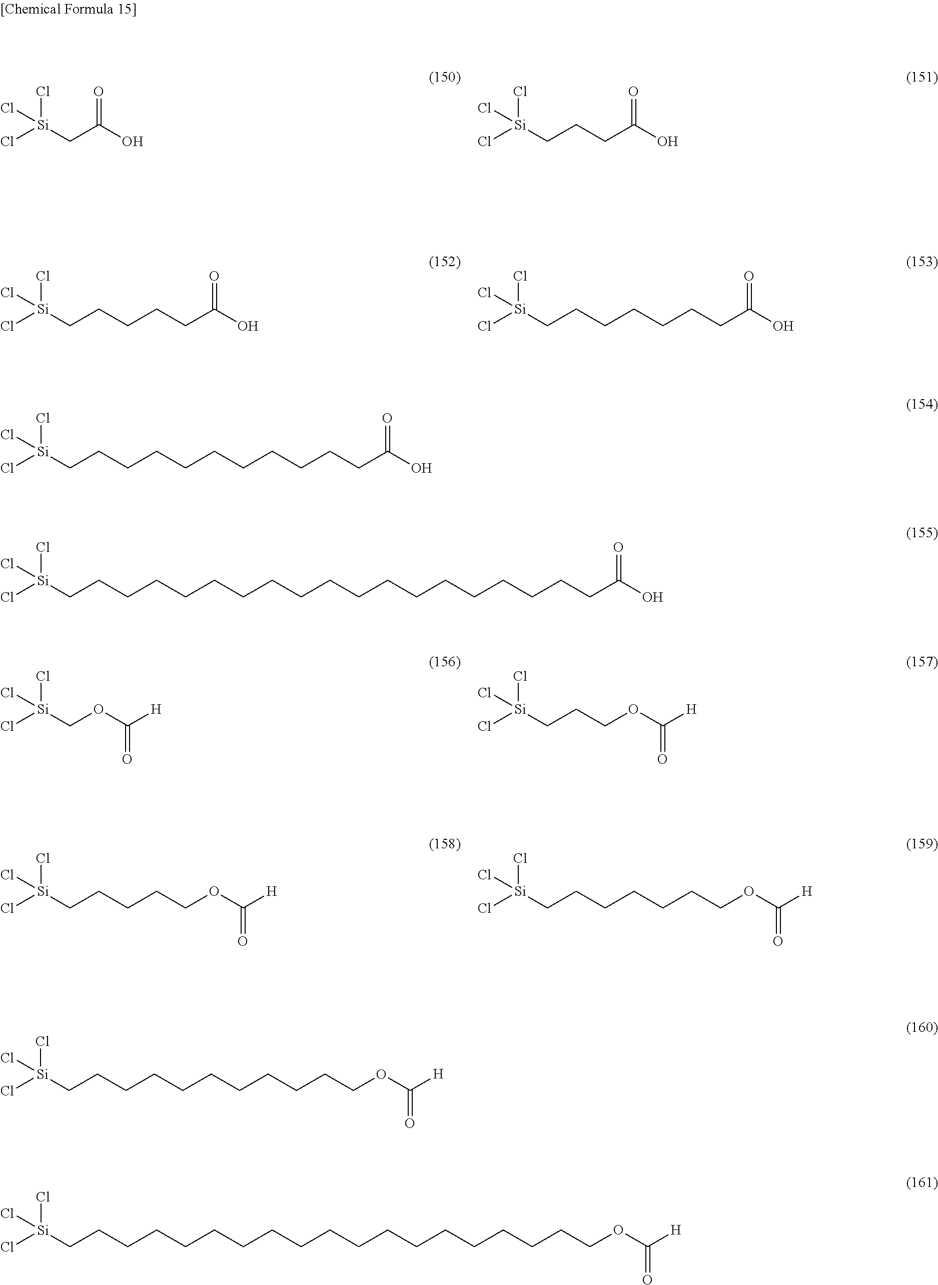

With the use of any of the above silicon compounds, the graphene compound that has a chain group having one or more ester groups or carboxyl groups can be formed. The graphene compound chemically modified with any of these silicon compounds has low electron conductivity and high lithium ion conductivity and thus is suitable as a solid electrolyte or a separator of a lithium-ion secondary battery. Note that the graphene compound of one embodiment of the present invention may be formed without using any of the above-mentioned silicon compounds.

In this embodiment, one embodiment of the present invention has been described. Other embodiments of the present invention are described in other embodiments. Note that one embodiment of the present invention is not limited to the above examples. For example, although an example of the graphene compound that has a chain group having one or more ester groups or carboxyl groups is described as one embodiment of the present invention, one embodiment of the present invention is not limited to this example.

This embodiment can be combined with any other embodiment as appropriate.

### Embodiment 4

A novel power storage device can be provided using the solid electrolyte obtained in the above embodiment.

A novel power storage device can be mounted on a power source for driving a portable information terminal such as a mobile phone, a hearing aid, an imaging device, a vacuum cleaner, an electric tool, an electric shaver, a lighting device, a toy, a medical device, a robot, an electric vehicle (hybrid car) and the like, a power storage source of buildings including houses, and the like.

Moreover, the novel power storage device can supply power to a variety of components and also perform charging and store power from other power sources. Thus, it can be used as a power storage device in a power generation facility, such as a solar cell, leading to energy saving and CO₂ reduction.

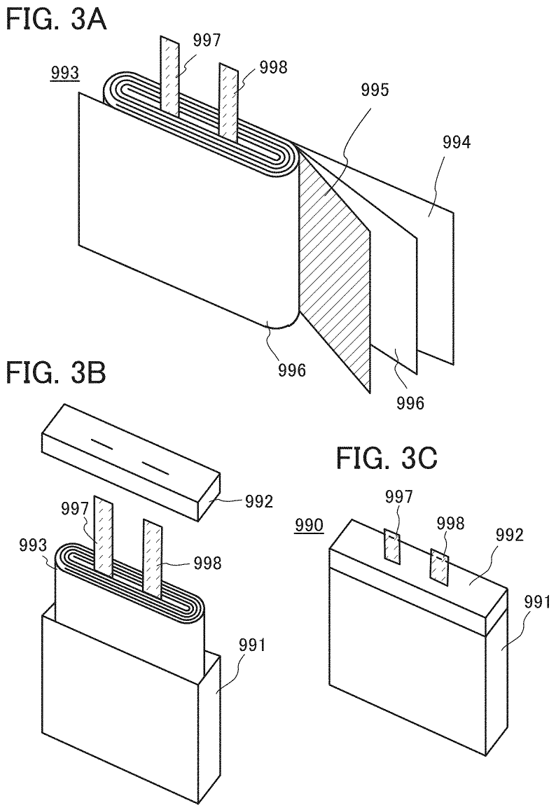

FIGS. 3A to 3C illustrate structure examples of thin storage batteries. A wound body 993 illustrated in FIG. 3A includes a negative electrode 994, a positive electrode 995, and a separator 996.

The wound body 993 is obtained by winding a sheet of a stack in which the negative electrode 994 overlaps with the positive electrode 995 with the separator 996 provided therebetween. The wound body 993 is covered by a rectangular sealed container or the like; thus, a rectangular power storage device is fabricated.

Note that the number of stacks each including the negative electrode 994, the positive electrode 995, and the separator 996 is determined as appropriate depending on capacity and element volume which are required. The negative electrode 994 is connected to a negative electrode current collector (not illustrated) via one of a lead electrode 997 and a lead electrode 998. The positive electrode 995 is connected to a positive electrode current collector (not illustrated) via the other of the lead electrode 997 and the lead electrode 998.

In the power storage device 990 illustrated in FIGS. 3B and 3C, the wound body 993 is packed in an exterior body 991. The wound body 993 includes the lead electrode 997 and the lead electrode 998, and is soaked in an electrolytic solution inside a space surrounded by the exterior body 991 and an exterior body 992. For example, a metal material such as aluminum or a resin material can be used for the exterior bodies 991 and 992. With the use of a resin material for the exterior bodies 991 and 992, the exterior bodies 991 and 992 can be changed in their forms when external force is applied; thus, a flexible thin power storage device can be fabricated.

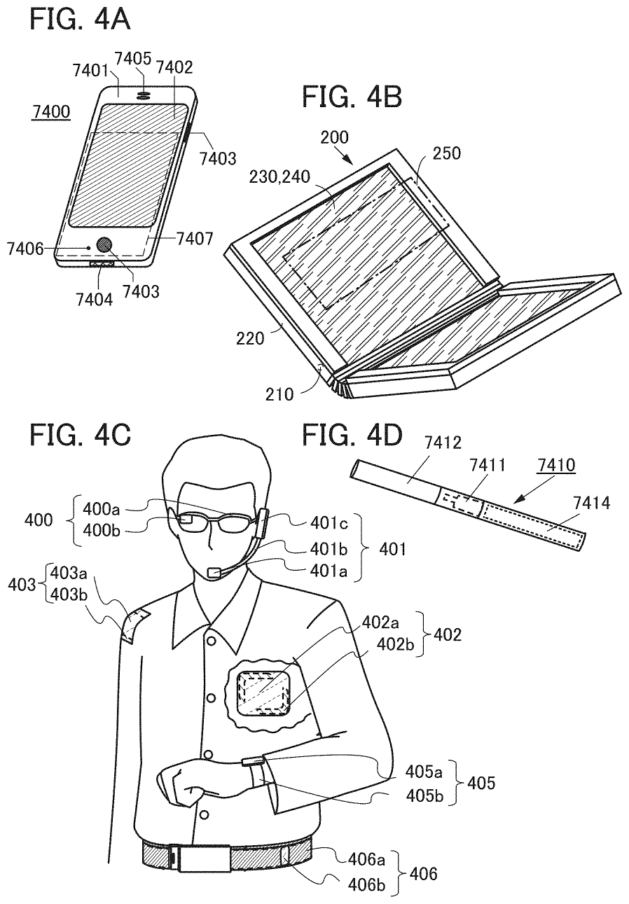

FIG. 4A illustrates an example of a mobile phone. A mobile phone 7400 is provided with a display portion 7402 incorporated in a housing 7401, an operation button 7403, an external connection port 7404, a speaker 7405, a microphone 7406, and the like. Note that the mobile phone 7400 includes a power storage device 7407.

FIG. 4B is a projection view illustrating an example of an external view of the data processor 200. The information processing device 200 described in this embodiment includes an arithmetic device 210, an input/output device 220, a display portion 230, and a power storage device 250.

The information processing device 200 includes a communication portion having a function of supplying data to a network and acquiring data from the network. Image information may be generated in accordance with received information distributed among a specific space using the communication portion 290. For example, educational materials can be distributed among a classroom and displayed to be used as a school book. Alternatively, materials transmitted among a conference room in a company can be received and displayed.

The power storage device using the graphene compound of one embodiment of the present invention can be provided in wearable devices illustrated in FIG. 4C.

For example, the power storage device can be provided in a glasses-type device 400 illustrated in FIG. 4C. The glasses-type device 400 includes a frame 400a and a display part 400b. The power storage device is provided in a temple of the frame 400a having a curved shape, whereby the glasses-type device 400 can have a well-balanced weight and can be used continuously for a long time.

The secondary battery 100 can be provided in a headset-type device 401. The headset-type device 401 includes at least a microphone part 401a, a flexible pipe 401b, and an earphone part 401c. The power storage device can be provided in the flexible pipe 401b and the earphone portion 401c.

Furthermore, the secondary battery 100 can be provided in a device 402 that can be attached directly to a body. A power storage device 402b can be provided in a thin housing 402a of the device 402.

Furthermore, the secondary battery 100 can be provided in a device 403 that can be attached to clothes. A power storage device 403b can be provided in a thin housing 403a of the device 403.

Furthermore, the power storage device can be provided in a watch-type device 405. The watch-type device 405 includes a display portion 405a and a belt portion 405b, and the power storage device can be provided in the display portion 405a or the belt portion 405b. The power storage device provided in the belt portion 405b preferably has flexibility. The power storage device may have a surface curved along an arm.

The display portion 405a can display various kinds of information such as time and reception information of an e-mail or an incoming call.

In addition, the watch-type device 405 is a wearable device that is wound around an arm directly; thus, a sensor that measures the pulse, the blood pressure, or the like of the user may be incorporated therein. Data on the exercise quantity and health of the user can be stored to be used for health maintenance.

Furthermore, the power storage device can be provided in a belt-type device 406. The belt-type device 406 includes a belt portion 406a and a wireless power feeding and receiving portion 406b, and the power storage device can be provided inside the belt portion 406a.

When the power storage device of one embodiment of the present invention is used as a power storage device of a daily electronic device, a lightweight product with a long lifetime can be provided. As the daily electronic products, an electric toothbrush, an electric shaver, electric beauty equipment, and the like are given. As power storage devices of these products, in consideration of handling ease for users, small and lightweight stick type power storage devices with high capacity are desired. FIG. 4D is a perspective view of a device which is called a vaporizer. In FIG. 4D, a vaporizer 7410 includes an atomizer 7411 including a heating element, a power storage device 7414 supplying power to the atomizer, and a cartridge 7412 including a liquid supply bottle, a sensor, and the like. To improve safety, a protection circuit which prevents overcharge and overdischarge of the power storage device 7414 may be electrically connected to the power storage device 7414. The power storage device 7414 in FIG. 4D includes an output terminal for connecting to a charger. When the vaporizer 7410 is held by a user, the power storage device 7414 becomes a tip portion; thus, it is preferable that the power storage device 7414 have a short total length and be lightweight. With the power storage device of one embodiment of the present invention which has high capacity and excellent cycle characteristics, the small and lightweight vaporizer 7410 which can be used for a long time for a long period can be provided.

The use of power storage devices in vehicles enables production of next-generation clean energy vehicles such as hybrid electric vehicles (HEVs), electric vehicles (EVs), and plug-in hybrid electric vehicles (PHEVs).

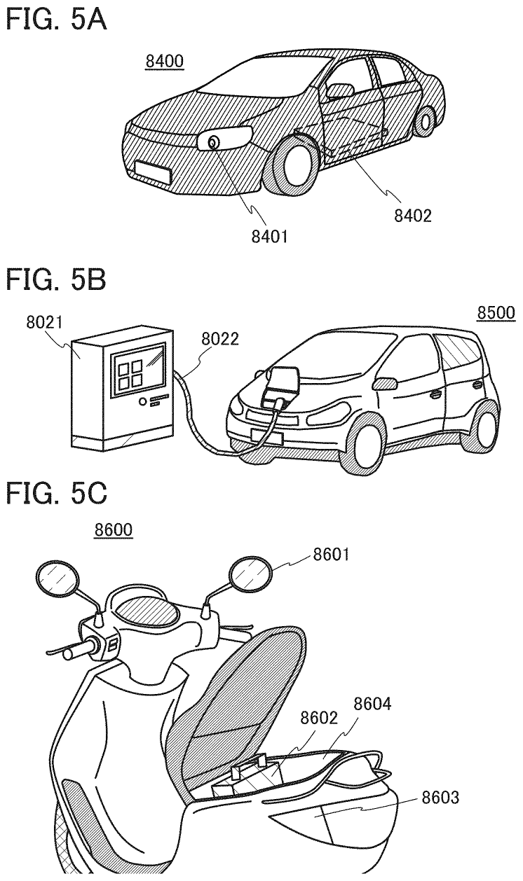

An automobile 8400 illustrated in FIG. 5A is an example of a hybrid electric vehicle (REV) provided with a power storage device 8402. The power storage device 8402 is used as a power supply for driving a vehicle or a power supply of a headlight 8401 or the like.

FIG. 5B illustrates an automobile 8500, which is an EV including the power storage device. The automobile 8500 can be charged when the power storage device is supplied with electric power through external charging equipment by a plug-in system, a contactless power feeding system, or the like. In FIG. 5B, a power storage device included in the automobile 8500 is charged with the use of a ground-based charging apparatus 8021 through a cable 8022. In charging, a given method such as CHAdeMO (registered trademark) or Combined Charging System may be employed as a charging method, the standard of a connector, or the like as appropriate. The ground-based charging apparatus 8021 may be a charging station provided in a commerce facility or a power source in a house. For example, with the use of a plug-in technique, the power storage device included in the automobile 8500 can be charged by being supplied with electric power from outside, for example. The charging can be performed by converting AC electric power into DC electric power through a converter such as an AC-DC converter.

Furthermore, although not illustrated, the vehicle may include a power receiving device so that it can be charged by being supplied with electric power from an above-ground power transmitting device in a contactless manner. In the case of the contactless power feeding system, by fitting a power transmitting device in a road or an exterior wall, charging can be performed not only when the electric vehicle is stopped but also when driven. In addition, the contactless power feeding system may be utilized to perform transmission and reception of electric power between vehicles. Furthermore, a solar cell may be provided in the exterior of the automobile to charge the power storage device when the automobile stops or moves. To supply electric power in such a contactless manner, an electromagnetic induction method or a magnetic resonance method can be used.

Furthermore, the power storage device included in the vehicle can be used as a power source for supplying electric power to products other than the vehicle. In such a case, the use of a commercial power source can be avoided at peak time of electric power demand.

The power storage device can be used as a power source of not only a large four-wheeled vehicle but also a small vehicle. For example, the power storage device can be used for a two-wheeled motor vehicle such as a scooter, a boarding-type mobile assistive robot that has a plane to put the foot between the two wheels and moves by passenger's movement of the center of gravity and the like.

A motor scooter 8600 illustrated in FIG. 5C includes a power storage device 8602, side mirrors 8601, and indicators 8603. The power storage device 8602 can supply electric power to the indicator 8603.

The power storage device 8602 used in this embodiment has high heat resistance and thus can be used in a severe environment, e.g., in a car for a long time. Furthermore, the power storage device 8602 in this embodiment can be used over a wide environmental temperature range and thus is useful.

This embodiment can be combined with any other embodiment as appropriate.

### EXAMPLE 1

A unit cell in which the layer containing the graphene compound described in the above embodiments was used for a solid electrolyte of a secondary battery was formed and was subjected to measurements of charge and discharge characteristics.

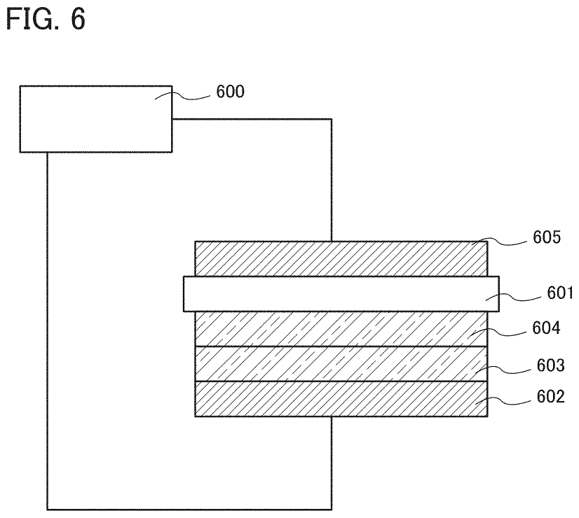

FIG. 6 is a schematic cross-sectional view showing a secondary battery electrically connected to a measurement device 600 and the sample in which the layer containing the graphene compound is used as the solid electrolyte layer of the secondary battery. A Li₄Ti₅O₁₂ thin film 602 (produced by TOSHIMA Manufacturing Co., Ltd.), a first PEO film 603, a second PEO film 604, a layer 601 containing the graphene compound (graphene compound+LiTFSA), and a LiCoO₂ thin film 602 (produced by TOSHIMA Manufacturing Co., Ltd.) were assembled to form the solid battery. In the example shown in this example, LiTFSA (LiN(CF₃SO₂)₂: Lithium trifluoromethanesulfonyl amide) was used as a lithium salt mixed with the graphene compound. However, other lithium salts (LiPF₆, LiClO₄, LiAsF₆, LiBF₄, LiAlCl₄, LiSCN, LiBr, LiI, Li₂SO₄, Li₂B₁₀Cl₁₀, Li₂B₂Cl₁₂, LiCF₃SO₃, LiC₄F₉SO₃, LiC(CF₃SO₂)₃, LiC(C₂F₅SO₂)₃, LiN(C₄F₉SO₂)(CF₃SO₂), LiN(C₂F₅SO₂)₂, and the like) may be used with no particular limitation. Note that the layer containing the graphene compound was obtained in the following manner: a mixed solution of 300 μL of THF (tetrahydrofuran) solution containing 3.3 wt % of the graphene compound and 100 μL of THF solution containing 5.1 wt % of LiTFSA was dried on a NAFLON (registered trademark) film. The first and second PEO films were obtained in the following manner: a mixed solution of about 1 g of PEO, about 0.32484 g of LiTFSA. and 15 ml of acetonitrile was dried on a NAFLON (registered trademark) film. In the drying process, the materials were retained in a vacuum at 90° C. and then exposed to the air for 24 hours.

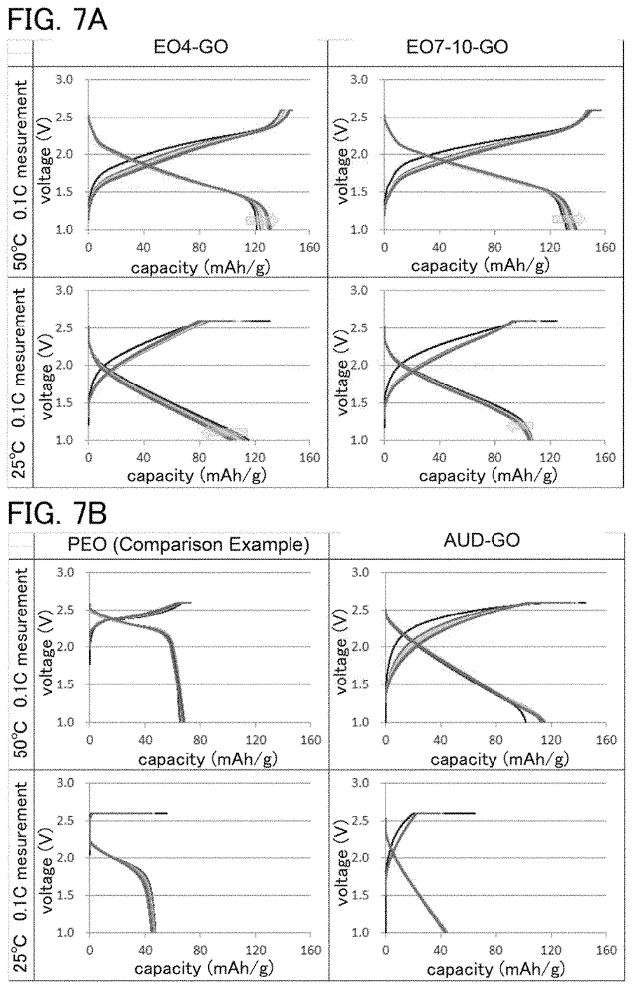

FIGS. 7A and 7B show measurement results of charge and discharge characteristics of the obtained unit cells for a power storage device using the solid electrolyte.

A material denoted by EO4-GO which is an ether-modified graphene compound in FIG. 7A corresponds to Chemical Formula 2 shown above. The thickness of the layer containing the graphene compound was 29 μm. A material denoted by EO7-10-GO which is an ether-modified graphene compound corresponds to Chemical Formula 3 shown above. The thickness of the layer containing the graphene compound was 88 μm. A material denoted by AUD-GO which is an ether-modified graphene compound corresponds to Chemical Formula 4 shown above. The thickness of the layer containing the graphene compound was 25 μm.

The conductivity of the graphene compound (EO7-10-GO) dried in a vacuum atmosphere at 70° C. for one hour was 1×10⁻⁸S/cm. The conductivity of the graphene compound dried in a vacuum atmosphere at 100° C. for one hour was 3.1×10⁻⁹ S/cm. The conductivity of the graphene compound dried in a vacuum atmosphere at 170° C. for one hour was 3.2×10⁻¹S/cm.

As shown in FIGS. 7A and 7B, the ether-modified graphene compounds and the ester-modified graphene compound demonstrated normal operation as solid electrolytes of a secondary battery, it can be said that the ether-modified graphene compounds showed better characteristics as a solid electrolyte of a secondary battery than a comparison example including only PEO.

The charge and discharge characteristics shown in FIGS. 7A and 7B were measured in the following manner.

The rate was calculated when the theoretical capacity of a positive electrode is 137 mAh/g. Constant current constant voltage (CCCV) charge was performed at a charge voltage of 2.6 V, and constant current (CC) discharge was performed at a discharge voltage of 1 V.

Here, constant current (CC) charge, CCCV charge, and CC discharge will be described.

### <<CC Charging>>

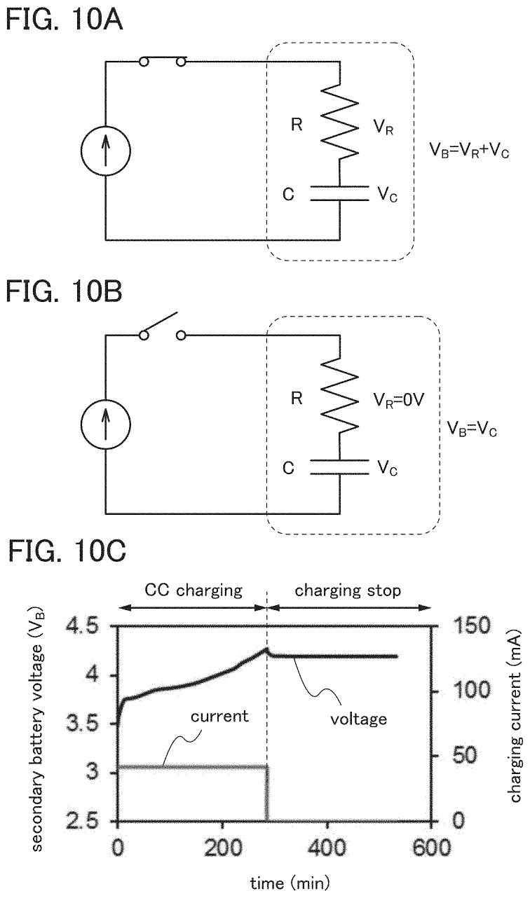

CC charging is described. CC charging is a charging method in which a constant current is made to flow to a secondary battery in the whole charging period and charging is terminated when the voltage reaches a predetermined voltage. The secondary battery is assumed to be expressed by an equivalent circuit with internal resistance R and secondary battery capacity C as illustrated in FIG. 10A. In this case, a secondary battery voltage V_{B} is the sum of a voltage V_{R} applied to the internal resistance R and a voltage V_{C} applied to the secondary battery capacity C.

While the CC charging is performed, a switch is on as illustrated in FIG. 10A, so that a constant current I flows to the secondary battery. During the period, the current I is constant; thus, according to the Ohm's law (V_{R}=R×I), the voltage V_{R} applied to the internal resistance R is also constant. In contrast, the voltage V_{C} applied to the secondary battery capacity C increases over time. Accordingly, the secondary battery voltage V_{B} increases over time.

When the secondary battery voltage Va reaches a predetermined voltage, e.g., 4.1 V, the charging is terminated. On termination of the CC charging, the switch is turned off as illustrated in FIG. 10B, and the current I becomes 0. Thus, the voltage V_{R} applied to the internal resistance R becomes 0 V. Consequently, the secondary battery voltage V_{B} is decreased by the lost voltage drop in the internal resistance R.

FIG. 10C shows an example of the secondary battery voltage V_{B} and charging current while the CC charging is performed and after the CC charging is terminated. The secondary battery voltage V_{B} increases while the CC charging is performed, and slightly decreases after the CC charging is terminated.

### <<CCCV Charging>>

Next, CCCV charging will be described. CCCV charging is a charging method in which CC charging is performed until the voltage reaches a predetermined voltage and then CV (constant voltage) charging is performed until the amount of current flow becomes small, specifically, a termination current value.

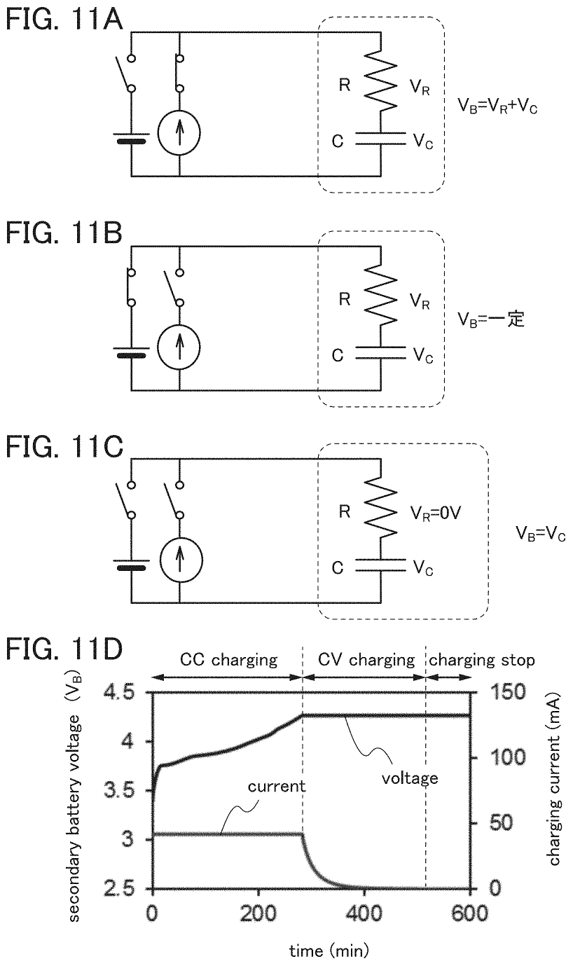

While the CC charge is performed, a switch of a constant current power source is on and a switch of a constant voltage power source is off as illustrated in FIG. 11A, so that the constant current I flows to the secondary battery. During the period, the current I is constant; thus, according to the Ohm's law (V_{R}=R×I), the voltage V_{R} applied to the internal resistance R is also constant. In contrast, the voltage V_{C} applied to the secondary battery capacity C increases over time. Accordingly, the secondary battery voltage V_{B} increases over time.

When the secondary battery voltage V_{B} reaches a predetermined voltage, e.g., 4.3 V, switching is performed from the CC charge to the CV charge. While the CV charge is performed, the switch of the constant voltage power source is on and the switch of the constant current power source is off as illustrated in FIG. 11B; thus, the secondary battery voltage V_{B} is constant. In contrast, the voltage V_{C} applied to the secondary battery capacitance C increases over time. Since V_{B}=V_{R}+V_{C} is satisfied, as the current I flowing in the secondary battery decreases, the voltage V_{R} applied to the internal resistance R decreases over time according to the Ohm's law (V_{R}=R×I). As the voltage V_{R} applied to the internal resistance R decreases, the secondary battery voltage V_{B} becomes constant.

When the current I flowing to the secondary battery becomes a predetermined current, e.g., approximately 0.01 C, charging is terminated. On termination of the CCCV charge, all the switches are turned off as illustrated in FIG. 11C, so that the current I becomes 0. Thus, the voltage V_{R} applied to the internal resistance R becomes 0 V. However, the voltage V_{R} applied to the internal resistance R becomes sufficiently small by the CV charging; thus, even when a voltage drop no longer occurs in the internal resistance R, the secondary battery voltage V_{B}hardly decreases.

FIG. 11D shows an example of the secondary battery voltage V_{B} and charging current while the CCCV charging is performed and after the CCCV charging is terminated. Even after the CCCV charging is terminated, the secondary battery voltage V_{B} hardly decreases.

### <<CC Discharging>>

Next, CC discharging will be described. CC discharging is a discharging method in which a constant current is made to flow from a secondary battery in the whole discharging period and discharging is ended when the secondary battery voltage V_{B} reaches a predetermined voltage, e.g., 2.5 V.

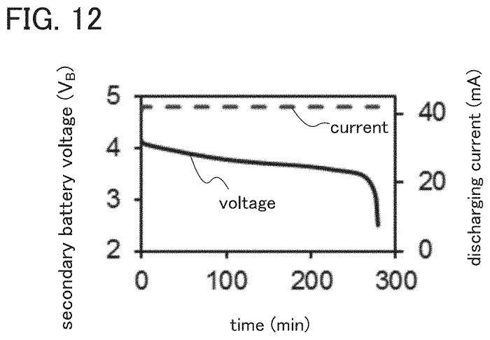

FIG. 12 shows an example of the secondary battery voltage V_{B} and discharging current while the CC discharge is performed. As discharging proceeds, the secondary battery voltage V_{B} decreases.

Next, a charge rate and a discharge rate will be described. The discharge rate refers to the relative ratio of discharging current to battery capacity and is expressed in a unit C. A current of approximately 1 C in a battery with a rated capacity X(Ah) is X A. The case where discharging is performed at a current of 2X A is rephrased as follows: discharging is performed at 2 C. The case where discharging is performed at a current of X/5 A is rephrased as follows: discharging is performed at 0.2 C. Similarly, the case where charging is performed at a current of 2X A is rephrased as follows: charging is performed at 2 C, and the case where charging is performed at a current of X/5 A is rephrased as follows: charging is performed at 0.2 C.

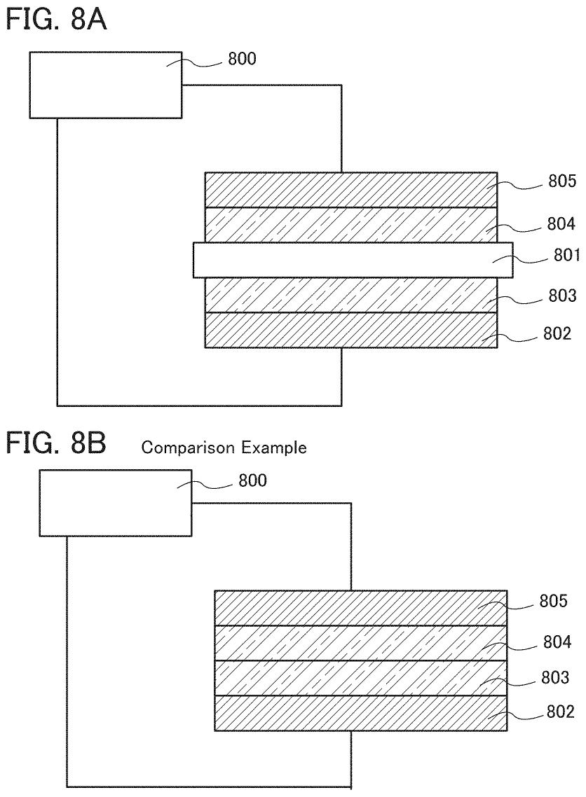

Next, the ion conductivity of a layer containing a graphene compound is measured. FIG. 8A is a schematic cross-sectional view of a sample in which a first PEO film 803, a second PEO film 804, and a layer 801 containing a graphene compound are sandwiched between a pair of stainless steel electrodes 802 and 805 electrically connected to a measurement device 800. FIG. 8B is a schematic cross-sectional view of a comparison cell in which only the first PEO film 803 and the second PEO film 804 are sandwiched between the pair of stainless steel electrodes electrically connected to the measurement device 800.

For the comparison cell in which only the first PEO film 803 and the second PEO film 804 are sandwiched between the pair of stainless steel electrodes, two films were formed by vacuum-drying at 65° C. using a mixed solution of about 1 g of PEO, about 0.32584 g of LiTFSA, and 15 ml of acetonitrile. The total thickness of the two PEO films was 190 μm. Although the stainless steel electrode was used as a current collector in this example, an aluminum electrode may be used.

An AUD-GO film obtained by vacuum-drying at 90° C. using a THF solution as a solvent had a thickness of 37 μm. Two films were formed by vacuum-drying at 65° C. using a mixed solution of about 1 g of PEO, about 0.32584 g of LiTFSA, and 15 ml of acetonitrile. The 37-μm-thick AUD-GO film was sandwiched therebetween. The 37-μm-thick AUD-GO film was obtained in the following manner: a mixed solution of 300 μL of THF (tetrahydrofuran) solution containing 3.3 wt % of AUD-GO and 100 μL of THF solution containing 3.7988 g of THF and 0.2046 g of LiTFSA was dried on a NAFLON (registered trademark) film. In this manner, the sample including the 37-μm-thick AUD-GO film sandwiched between the two PEO films was formed (the total thickness of PEO/AUD-GO/PEO was 144 μm).

An AUDEO4-GO film was obtained in the following manner: a mixed solution of 300 μL of THF (tetrahydrofuran) solution containing 3.3 wt % of AUDEO4-GO and 100 μL of THF solution containing 5.1 wt % of LiTFSA was dried on a NAFLON (registered trademark) film. The thickness of the AUDEO4-GO film was 32 μm. In this manner, the sample including the 32-μm-thick AUDEO4-GO film sandwiched between the two PEO films was formed (the total thickness of PEO/AUDEO4-GO/PEO was 145 μm). The material denoted by AUDEO4-GO which is the ether-modified and ester-modified graphene compound corresponds to Chemical Formula 5 shown above.

An EO4-GO film was obtained in the following manner: a mixed solution of 300 μL of THF (tetrahydrofuran) solution containing 3.3 wt % of EO4-GO and 100 μL of THF solution containing 5.1 wt % of LiTFSA was dried on a NAFLON (registered trademark) sheet. The thickness of the EO4-GO film was 52 μm. In this manner, the sample including the 52-μm-thick EO4-GO film sandwiched between the two PEO films was formed (the total thickness of PEO/EO4-GO/PEO was 151 μm).

An EO7-10-GO film was obtained in the following manner: a mixed solution of 300 μL of THF (tetrahydrofuran) solution containing 3.3 wt % of EO7-10-GO and 100 μL of THF solution containing 5.1 wt % of LiTFSA was dried on a NAFLON (registered trademark) sheet. The thickness of the EO7-10-GO film was 41 μm. In this manner, the sample including the 41-μm-thick EO7-10-GO film sandwiched between the two PEO films was formed (the total thickness of PEO/EO7-10-GO/PEO was 299 μm).

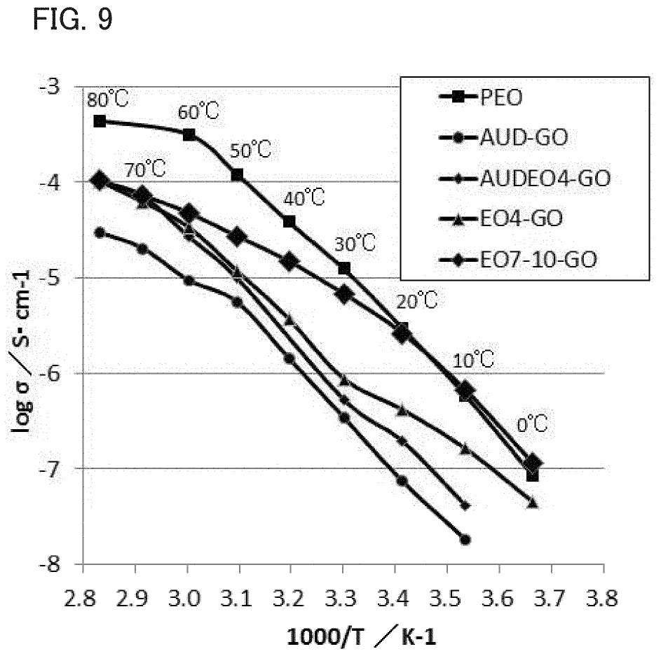

FIG. 9 shows results of calculating lithium ion conductivity by AC impedance measurement with the measurement device 800. Note that measurements at 25° C. were performed after cell assembly. Then, measurements at 0° C. to 80° C. were performed after retention for 3 hours at 60° C. Finally, measurements at 25° C. were performed. The results in FIG. 9 show that lithium ion conduction was observed in these graphene compounds. For the AC impedance measurement, a lithium salt (LiTFSA) was added to the graphene compound.

As shown in FIG. 9, the lithium ion conductivity of the ether-modified graphene compound (EO7-10-GO) at 20° C. or lower is equivalent to or higher than that of the comparison example.

The above results show that the ether-modified or ester-modified graphene compound has sufficient lithium ion conductivity for a solid electrolyte of a solid battery and is suitable as a solid electrolyte of a solid battery. This is probably because oxygen contained in ether or ester has high polarity and contributes to the dissociation of a lithium salt and the transfer of lithium ions. It was also found that solid electrolyte films can be easily formed using these graphene compounds because they were easily made into a film.

### EXAMPLE 2

In this example, a layer containing an ether-modified and ester-modified graphene compound (AUDEO4-GO) is formed.

The material denoted by AUDEO4-GO which is the ether-modified and ester-modified graphene compound corresponds to Chemical Formula 5 shown above.

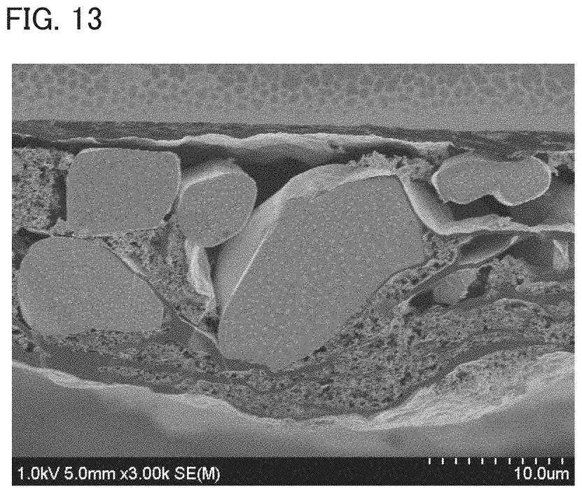

The layer was formed to have LiCoO₂: AUDEO4-GO: LiTFSA: AB=50: 26.4: 13.6: 10. FIG. 13 shows a cross-sectional image of the obtained layer containing the ether-modified and ester-modified graphene compound (AUDEO4-GO).

Then, a layer containing a graphene compound (AUDEO4-GO), a PEO film, and lithium foil were formed on the obtained layer. In this manner, a sample was formed.

### EXAMPLE 3

In this example, a layer containing an ether-modified graphene compound (EO7-10-GO) is formed.

The material denoted by EO7-10-GO which is an ether-modified graphene compound corresponds to Chemical Formula 3 shown above.

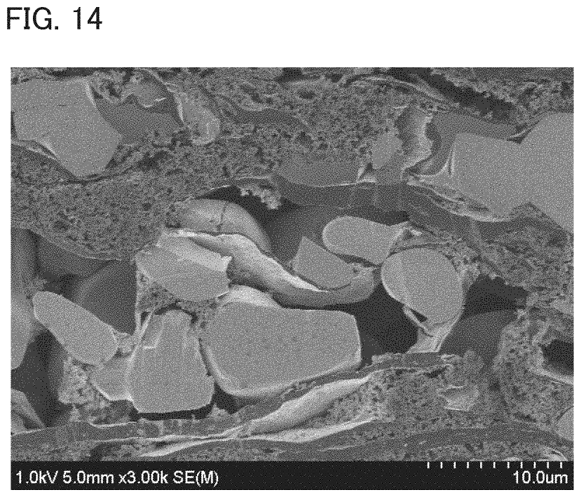

The layer was formed to have LiCoO₂: EO7-10-GO: LiTFSA: AB=50: 26.4: 13.6: 10. FIG. 14 shows a cross-sectional image of the obtained layer containing the ether-modified graphene compound (EO7-10-GO).

Then, a layer containing a graphene compound (EO7-10-GO film), a PEO film, and lithium foil were formed on the obtained layer. In this manner, a sample was formed.

### REFERENCE NUMERALS

100: lithium-ion secondary battery
101: positive electrode
102: negative electrode
103: layer containing graphene compound
104: substrate
105: wiring electrode
106: wiring electrode
107: positive electrode active material
108: negative electrode active material
111: current collector
112: current collector
113: layer containing graphene compound
113a: layer containing graphene compound
113b: layer containing graphene compound
113c: layer containing graphene compound
119: solid electrolyte layer
200: data processor
210: arithmetic unit
220: input/output device
230: display portion
250: power storage device
290: communication portion
300: THF solution
400: glasses-type device
400a: frame
400b: display portion
401: earphone device
401a: microphone part
401b: flexible pipe
401c: earphone portion
402: device
402a: housing
402b: power storage device
403: device
403a: housing
403b: power storage device
405: watch-type device
405a: display portion
405b: belt portion
406: belt-type device
406a: belt portion
406b: wireless power feeding and receiving portion
600: measurement device
601: layer containing graphene compound
602: thin film
603: first PEO film
604: second PEO film
800: measurement device
801: layer containing graphene compound
802: stainless steel electrode
803: first PEO film
804: second PEO film
805: stainless steel electrode
990: power storage device
991: exterior body
992: exterior body
993: wound body
994: negative electrode
995: positive electrode
996: separator
997: lead electrode
998: lead electrode
7400: mobile phone
7401: housing
7402: display portion
7403: operation button
7404: external connection port
7405: speaker
7406: microphone
7407: power storage device
7410: vaporizer
7411: atomizer
7412: cartridge
7414: power storage device
8021: charging device
8022: cable
8400: automobile
8401: headlight
8402: power storage device
8500: automobile
8600: motor scooter
8601: side mirror
8602: power storage device
8603: indicator

This application is based on Japanese Patent Application Serial No. 2016-239821 filed with Japan Patent Office on Dec. 9, 2016, the entire contents of which are hereby incorporated by reference.

1. A secondary battery comprising:
a first electrode containing a positive electrode active material;
a second electrode containing a negative electrode active material; and
a layer containing a graphene compound,
wherein the layer containing a graphene compound has an ion conductivity and is configured to prevent a short circuit between the first electrode and the second electrode.

2. The secondary battery according to claim 1, wherein the layer containing a graphene compound has a function of a solid electrolyte layer.

3. The secondary battery according to claim 1, wherein the layer containing a graphene compound includes oxygen and a functional group.

4. The secondary battery according to claim 3, wherein tine functional group is ether.

5. The secondary battery according to claim 3, wherein the functional group is ester.

6. The secondary battery according to claim 3, wherein the layer containing a graphene compound further includes silicon.

7. The secondary battery according to claim 6,
wherein the layer containing a graphene compound includes a graphene oxide,
wherein the silicon is bonded to oxygen of the graphene oxide, and
wherein the functional group is bonded to the silicon.

8. The secondary battery according to claim 6, wherein the functional group is ether.

9. The secondary battery according to claim 6, wherein the functional group is ester.

10. The secondary battery according to claim 1, wherein an end portion of the graphene compound is terminated with ester and is chemically modified with an alkyl group.

11. A secondary battery comprising:
a first electrode containing a positive electrode active material;
a first solid electrolyte layer;
a layer containing a graphene compound; and
a second electrode containing a negative electrode active material,
wherein the layer containing a graphene compound is between the solid electrolyte layer and the second electrode, and
wherein the layer containing a graphene compound has an ion conductivity and is configured to prevent a short circuit between the first electrode and the second electrode.

12. The secondary battery according to claim 11, further comprising:
a second solid electrolyte layer,
wherein the layer containing a graphene compound is between the first solid electrolyte layer and the second solid electrolyte layer.

13. The secondary battery according to claim 11, wherein the layer containing a graphene compound has a function of a solid electrolyte layer.

14. The secondary battery according to claim 11, wherein the layer containing a graphene compound includes oxygen and a functional group.

15. The secondary battery according claim 14, wherein the functional group is ether.

16. The secondary battery according to claim 14, wherein the functional group is ester.

17. The secondary battery according to claim 14, wherein the layer containing a graphene compound further includes silicon.

18. The secondary battery according to claim 17,
wherein the layer containing a graphene compound includes a graphene oxide,
wherein the silicon is bonded to oxygen of the graphene oxide, and
wherein the functional group is bonded to the silicon.

19. The secondary battery according to claim 17, wherein the functional group is ether.

20. The secondary battery according to claim 17, wherein the functional group is ester.

21. The secondary battery according to claim 14, wherein an end portion of the graphene compound is terminated with ester and is chemically modified with an alkyl group.
